(19) United States
(12) Patent Application Publication
(10) Pub. No.: US 2004/0120861 A1
(43) Pub. Date: Jun. 24, 2004

(54) System and method for high-throughput processing of biological probe arrays

(75) Inventor: Christopher Petroff, Groton, MA (US)

Correspondence Address: AFFYMETRIX, INC, ATTN: CHIEF IP COUNSEL, LEGAL DEPT., 3380 CENTRAL EXPRESSWAY, SANTA CLARA, CA, 95051, US

(73) Assignee: Affymetrix, INC., Santa Clara, CA

(21) Appl. No.: 10/684,160

(22) Filed: Oct. 10, 2003

Related U.S. Application Data
(60) Provisional application No. 60/417,942, filed on Oct. 11, 2002.

(51) Int. Cl. B32B 5/02

(52) U.S. Cl. 422/100; 422/50

(57) ABSTRACT

A system for high throughput processing of a plurality of probe arrays is described that includes a means for holding a plurality of cartridges, where each cartridge includes a probe array capable of detecting biological molecules; a means for interfacing with a cartridge; and a manifold that couples each of the plurality of cartridges with one or more reservoirs, where each cartridge is coupled via the means for interfacing.

### RELATED APPLICATIONS

The present application claims priority to U.S. Provisional Patent Application serial No. 60/417,942, titled “Integrated High-Throughput Microarray System and Process”, filed Oct. 11, 2002, which is hereby incorporated by reference herein in its entirety for all purposes. The present application is also related to U.S. patent application Ser. No. 10/389,194, entitled “System, Method and Product for Scanning of Biological Materials”, filed Mar. 14, 2003; and Patent Cooperation Treaty Application Number PCT/US02/13883, entitled “High Throughput Microarray Spotting System and Method”, filed May 2, 2002, both of which are hereby incorporated herein by reference in their entireties for all purposes.

### BACKGROUND

1. Field of the Invention

The present invention relates to systems for automatically processing microarrays and biological samples. In particular, the invention relates to systems including elements for reading barcode information, and other elements such as scanner optics and detectors, hybridization modules, and an autoloader for storing and loading array chips into a scanning or hybridization device.

2. Related Art

Synthesized nucleic acid probe arrays, such as Affymetrix GeneChip® probe arrays, and spotted probe arrays, have been used to generate unprecedented amounts of information about biological systems. For example, the GeneChip® Human Genome U133 Set (HG-U133A and HG-U133B) available from Affymetrix, Inc. of Santa Clara, Calif., is comprised of two microarrays containing over 1,000,000 unique oligonucleotide features covering more than 39,000 transcript variants that represent more than 33,000 human genes. Analysis of expression data from such microarrays may lead to the development of new drugs and new diagnostic tools.

### SUMMARY OF THE INVENTION

Systems, methods, and products to address these and other needs are described herein with respect to illustrative, non-limiting, implementations. Various alternatives, modifications and equivalents are possible. For example, certain systems, methods, and computer software products are described herein using exemplary implementations for analyzing data from arrays of biological materials produced by the Affymetrix® 417™ or 427™ Arrayer. Other illustrative implementations are referred to in relation to data from Affymetrix® GeneChip® probe arrays. However, these systems, methods, and products may be applied with respect to many other types of probe arrays and, more generally, with respect to numerous parallel biological assays produced in accordance with other conventional technologies and/or produced in accordance with techniques that may be developed in the future. For example, the systems, methods, and products described herein may be applied to parallel assays of nucleic acids, PCR products generated from cDNA clones, proteins, antibodies, or many other biological materials. These materials may be disposed on slides (as typically used for spotted arrays), on substrates employed for GeneChip® arrays, or on beads, optical fibers, or other substrates or media. Moreover, the probes need not be immobilized in or on a substrate, and, if immobilized, need not be disposed in regular patterns or arrays. For convenience, the term “probe array” will generally be used broadly hereafter to refer to all of these types of arrays and parallel biological assays.

A system for high throughput processing of a plurality of probe arrays is described that includes a means for holding a plurality of cartridges, where each cartridge includes a probe array capable of detecting biological molecules; a means for interfacing with a cartridge; and a manifold that couples each of the plurality of cartridges with one or more reservoirs, where each cartridge is coupled via the means for interfacing.

In some embodiments the means for holding includes a carousel or magazine. In some implementations, the carousel may include a plurality of partitions that is each associated with an ultrasonic agitator that provides vibration to aid in mixing fluids. Also, each cartridge may include an aperture for accepting the means for interfacing, and two channels coupled by a pocket that houses the probe array. In some implementations, one of the two channels includes an additional air pocket for the purpose of forming a bubble of air or gas that may aid in mixing fluids.

Also, in some embodiments the probe array may include a synthesized or a spotted probe array. Additionally, the means for interfacing may include a pin or needle. In some implementations a needle could include what is referred to as a dual lumen needle that has an outer lumen and an inner lumen. For instance, the outer lumen may be used for the removal of fluids or gas and the inner lumen for the introduction of fluids or gas.

Other possible embodiments may also include each of the one or more reservoirs containing a fluid, such as a sample, wash, buffer, stain, bleach, or water.

The system may also include a fluid bath to provide thermal control for each of the probe array cartridges to promote optimal hybridization efficiency of the biological targets to the probe array.

A method is described that includes the acts of holding a number of cartridges that each include a probe array capable of detecting biological molecules; interfacing with each cartridge; and coupling each cartridge with one or more reservoirs via the interface.

A system is described that includes a carousel that holds a number of cartridges, each containing a probe array capable of detecting biological molecules; a fluid bath that provides thermal control of each of the probe array cartridges; a dual lumen needle that interfaces with each cartridge; and a manifold that couples each of the cartridges with one or more reservoirs via the dual lumen needle.

In some embodiments, the carousel includes partitions that are associated with an ultrasonic agitator that provides vibration to aid in mixing fluids. Also, the dual lumen needle includes an outer lumen for the removal of fluids or gas and an inner for the introduction of fluids or gas. Additionally, each of the one or more reservoirs includes a fluidly such as a sample, wash, buffer, stain, bleach, or water. In the same or other embodiment the thermal control promotes hybridization efficiency of biological targets to the probe array.

A method is described that includes the acts of holding a cartridges that each include a probe array capable of detecting biological molecules; providing thermal control of each of the cartridges; interfacing with each cartridge; and coupling each cartridge with one or more reservoirs.

A method, is described that includes the acts of holding a number of cartridges that each includes a probe array capable of detecting biological molecules; interfacing with each cartridge; coupling each cartridge with one or more reservoirs via the interface; and serially introducing a plurality of fluids into the probe array cartridge.

The above embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

### BRIEF DESCRIPTION OF THE DRAWINGS

The above and further features will be more clearly appreciated from the following detailed description when taken in conjunction with the accompanying drawings. In the drawings, like reference numerals indicate like structures or method steps and the leftmost digit of a reference numeral indicates the number of the figure in which the referenced element first appears (for example, the element 100 appears first in FIG. 1). In functional block diagrams, rectangles generally indicate functional elements and parallelograms generally indicate data. In method flow charts, rectangles generally indicate method steps and diamond shapes generally indicate decision elements. All of these conventions, however, are intended to be typical or illustrative, rather than limiting.

FIG. 1 is a functional block diagram of one embodiment of an integrated high throughput probe array analysis system connected to a laboratory information management system connected via a network;

FIG. 2 is a functional block diagram of one embodiment of the laboratory information management system and a computer workstation of FIG. 1 constructed and arranged to send and receive data to and from components of the high throughput probe array analysis system;

FIG. 3 is a functional block diagram of one embodiment of the computer workstation and a hybridization station, autoloader, and a scanner of FIGS. 1 and 2;

FIG. 4 is a functional block diagram of one embodiment of the autoloader of FIGS. 1, 2, and 3 that includes a barcode reader, cartridge magazine, and a cartridge transport assembly;

FIG. 5 is a functional block diagram of one embodiment of an experiment manager constructed and arranged for functional control of instruments based, at least in part, on information associated with barcode identifier data;

FIG. 6A is a simplified graphical illustration of one embodiment of a probe array cartridge;

FIG. 6B is a simplified graphical illustration of one embodiment of a plurality of the probe array cartridges of FIG. 6A disposed in a carousel associated with fluid transport elements; and

FIG. 6C is a simplified graphical illustration of one embodiment of the carousel of FIG. 6B positioned in a fluid bath.

### DETAILED DESCRIPTION

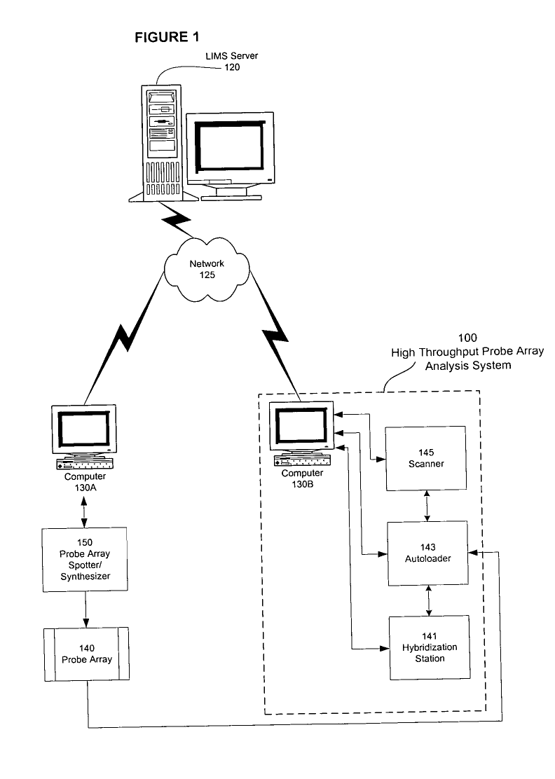

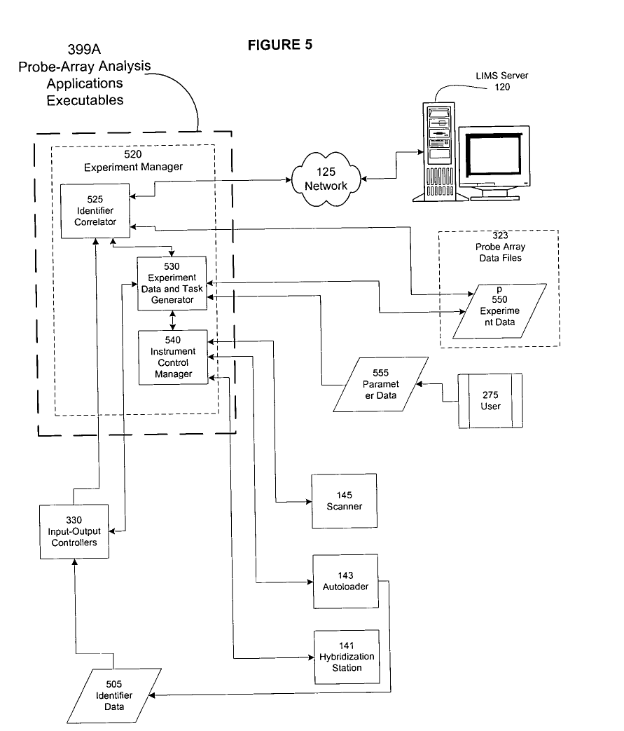

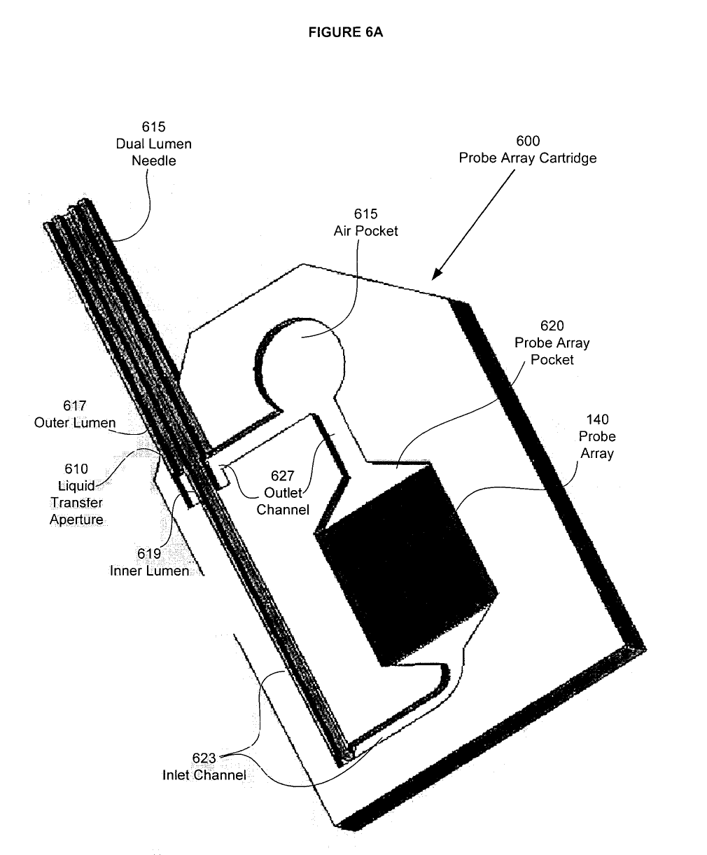

Integrated high throughput probe array analysis systems and processes are now described with reference to an illustrative embodiment referred to as experiment manager 520. Manager 520 is shown in a computer system environment in FIG. 5. In a typical implementation, manager 520 may be used to provide integrated system control and sample tracking without user intervention. More specifically, manager 520 coordinates the steps and processes performed by an integrated analysis system such as the illustrative example presented in FIG. 1 as high throughput probe array analysis system 100. For instance, Manager 520 manages the steps and processes performed by system 100 using identifiers associated with each probe array and sample experiment data. The identifiers enable manager 520 to track each probe array and implement the appropriate protocols and procedures unique to that probe array. Other functions of manager 520 may include creating and updating experiment data, receiving and processing emission intensity data, and publishing data to one or more databases. Further, manager 520 may display information to a user in one or more Graphical User Interfaces (hereafter referred to as GUI's) such as, for example, experiment data, process steps, or other information based, at least in part, on user selected criteria.

Probe Arrays 140: Various techniques and technologies may be used for synthesizing dense arrays of biological materials on or in a substrate or support. For example, Affymetrix® GeneChip® arrays are synthesized in accordance with techniques sometimes referred to as VLSIPS™ (Very Large Scale Immobilized Polymer Synthesis) technologies. Some aspects of VLSIPS™ and other microarray manufacturing technologies are described in U.S. Pat. Nos. 5,424,186; 5,143,854; 5,445,934; 5,744,305; 5,831,070; 5,837,832; 6,022,963; 6,083,697; 6,291,183; 6,309,831; and 6,310,189, all of which are hereby incorporated by reference in their entireties for all purposes. The probes of these arrays in some implementations consist of nucleic acids that are synthesized by methods including the steps of activating regions of a substrate and then contacting the substrate with a selected monomer solution. As used herein, nucleic acids may include any polymer or oligomer of nucleosides or nucleotides (polynucleotides or oligonucleotides) that include pyrimidine and/or purine bases, preferably cytosine, thymine, and uracil, and adenine and guanine, respectively. Nucleic acids may include any deoxyribonucleotide, ribonucleotide, and/or peptide nucleic acid component, and/or any chemical variants thereof such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states. Probes of other biological materials, such as peptides or polysaccharides as non-limiting examples, may also be formed. For more details regarding possible implementations, see U.S. Pat. No. 6,156,501, which is hereby incorporated by reference herein in its entirety for all purposes.

A system and method for efficiently synthesizing probe arrays using masks is described in U.S. patent application, Ser. No. 09/824,931; a system and method for a rapid and flexible microarray manufacturing and online ordering system is described in U.S. patent application, Ser. No. 10/065,868; and systems and methods for optical photolithography without masks are described in U.S. Pat. No. 6,271,957 and in U.S. patent application Ser. No. 09/683,374, all of which are hereby incorporated by reference herein in their entireties for all purposes.

The probes of synthesized probe arrays typically are used in conjunction with biological target molecules of interest, such as cells, proteins, genes or EST's, other DNA sequences, or other biological elements. More specifically, the biological molecule of interest may be a ligand, receptor, peptide, nucleic acid (oligonucleotide or polynucleotide of RNA or DNA), or any other of the biological molecules listed in U.S. Pat. No. 5,445,934 (incorporated by reference above) at column 5, line 66 to column 7, line 51. For example, if transcripts of genes are the interest of an experiment, the target molecules would be the transcripts. Other examples include protein fragments, small molecules, etc. Target nucleic acid refers to a nucleic acid (often derived from a biological sample) of interest. Frequently, a target molecule is detected using one or more probes. As used herein, a probe is a molecule for detecting a target molecule. A probe may be any of the molecules in the same classes as the target referred to above. As non-limiting examples, a probe may refer to a nucleic acid, such as an oligonucleotide, capable of binding to a target nucleic acid of complementary sequence through one or more types of chemical bonds, usually through complementary base pairing, usually through hydrogen bond formation. As noted above, a probe may include natural (i.e. A, G, U, C, or T) or modified bases (7-deazaguanosine, inosine, etc.). In addition, the bases in probes may be joined by a linkage other than a phosphodiester bond, so long as the bond does not interfere with hybridization. Thus, probes may be peptide nucleic acids in which the constituent bases are joined by peptide bonds rather than phosphodiester linkages. Other examples of probes include antibodies used to detect peptides or other molecules, any ligands for detecting its binding partners. When referring to targets or probes as nucleic acids, it should be understood that these are illustrative embodiments that are not to limit the invention in any way.

The samples or target molecules of interest (hereafter, simply targets) are processed so that, typically, they are spatially associated with certain probes in the probe array. For example, one or more tagged targets are distributed over the probe array. In accordance with some implementations, some targets hybridize with probes and remain at the probe locations, while non-hybridized targets are washed away. These hybridized targets, with their tags or labels, are thus spatially associated with the probes. The hybridized probe and target may sometimes be referred to as a probe-target pair. Detection of these pairs can serve a variety of purposes, such as to determine whether a target nucleic acid has a nucleotide sequence identical to or different from a specific reference sequence. See, for example, U.S. Pat. No. 5,837,832, referred to and incorporated above. Other uses include gene expression monitoring and evaluation (see, e.g., U.S. Pat. Nos. 5,800,992 and 6,040,138, and International Application No. PCT/US98/15151, published as WO99/05323), genotyping (U.S. Pat. No. 5,856,092), or other detection of nucleic acids, all of which are hereby incorporated by reference herein in their entireties for all purposes.

Other techniques exist for depositing probes on a substrate or support. For example, “spotted arrays” are commercially fabricated, typically on microscope slides. These arrays consist of liquid spots containing biological material of potentially varying compositions and concentrations. For instance, a spot in the array may include a few strands of short oligonucleotides in a water solution, or it may include a high concentration of long strands of complex proteins. The Affymetrix® 417™ Arrayer and 427™ Arrayer are devices that deposit densely packed arrays of biological materials on microscope slides in accordance with these techniques. Aspects of these, and other, spot arrayers are described in U.S. Pat. Nos. 6,040,193 and 6,136,269; in U.S. patent application Ser. No. 09/683,298; and in PCT Application Nos. PCT/US99/00730 (International Publication Number WO 99/36760), PCT/US02/13883, all of which are hereby incorporated by reference in their entireties for all purposes. Other techniques for generating spotted arrays also exist. For example, U.S. Pat. No. 6,040,193 to Winkler, et al. is directed to processes for dispensing drops to generate spotted arrays. The '193 patent, and U.S. Pat. No. 5,885,837 to Winkler, also describe the use of micro-channels or micro-grooves on a substrate, or on a block placed on a substrate, to synthesize arrays of biological materials. These patents further describe separating reactive regions of a substrate from each other by inert regions and spotting on the reactive regions. The '193 and '837 patents are hereby incorporated by reference in their entireties. Another technique is based on ejecting jets of biological material to form a spotted array. Other implementations of the jetting technique may use devices such as syringes or piezo electric pumps to propel the biological material. It will be understood that the foregoing are non-limiting examples of techniques for synthesizing, depositing, or positioning biological material onto or within a substrate. For example, although a planar array surface is preferred in some implementations of the foregoing, a probe array may be fabricated on a surface of virtually any shape or even a multiplicity of surfaces. Arrays may comprise probes synthesized or deposited on beads, fibers such as fiber optics, glass or any other appropriate substrate, see U.S. Pat. Nos. 6,361,947, 5,770,358, 5,789,162, 5,708,153 and 5,800,992, all of which are hereby incorporated in their entireties for all purposes. Arrays may be packaged in such a manner as to allow for diagnostics or other manipulation of in an all inclusive device, see for example, U.S. Pat. Nos. 5,856,174 and 5,922,591 incorporated in their entireties by reference for all purposes.

To ensure proper interpretation of the term “probe” as used herein, it is noted that contradictory conventions exist in the relevant literature. The word “probe” is used in some contexts to refer not to the biological material that is synthesized on a substrate or deposited on a slide, as described above, but to what has been referred to herein as the “target.” To avoid confusion, the term “probe” is used herein to refer to probes such as those synthesized according to the VLSIPS™ technology; the biological materials deposited so as to create spotted arrays; and materials synthesized, deposited, or positioned to form arrays according to other current or future technologies. Thus, microarrays formed in accordance with any of these technologies may be referred to generally and collectively hereafter for convenience as “probe arrays.” Moreover, the term “probe” is not limited to probes immobilized in array format. Rather, the functions and methods described herein may also be employed with respect to other parallel assay devices. For example, these functions and methods may be applied with respect to probe-set identifiers that identify probes immobilized on or in beads, optical fibers, or other substrates or media.

In many implementations probes are able to detect the expression of corresponding genes or EST's by detecting the presence or abundance of mRNA transcripts present in the target. This detection may, in turn, be accomplished in some implementations by detecting labeled cRNA that is derived from cDNA derived from the mRNA in the target.

Other implementations of probes may be designed to interrogate the sequence composition of DNA such as for instance, probes that interrogate single nucleotide polymorphisms (hereafter referred to as SNP's) or probes that interrogate the nucleotide composition at a specific sequence position. In some implementations, a process that is commonly referred to as polymerase chain reaction (hereafter referred to as PCR) may be used to amplify selected regions of DNA. An individual probe is capable of detecting a specific nucleic acid at a specific sequence position within a PCR product or DNA sequence. In general, a group of probes, sometimes referred to as a probe set, contains sub-sequences in unique regions of the transcripts and does not correspond to a full gene sequence.

For example, one possible embodiment of SNP probes may be present on the array so that each SNP is represented by a collection of probes. The array may comprise between 8 and 80 probes for each SNP. In one embodiment the collection comprises about 56 probes for each SNP. The probes may be present in sets of 8 probes that correspond to a perfect match or PM probe for each of two alleles, a mismatch or MM probe for each of 2 alleles, and the corresponding probes for the opposite strand. So for each allele there may be a perfect match, a perfect mismatch, an antisense match and an antisense mismatch probe. The polymorphic position may be the central position of the probe region, for instance, the probe region may be 25 nucleotides and the polymorphic allele may be in the middle with 12 nucleotides on either side. In other probe sets the polymorphic position may be offset from the center. In the present example, the polymorphic position may be from 1 to 5 bases from the central position on either the 5′ or 3′ side of the probe. The interrogation position, which may be changed in the mismatch probes, may remain at the center position. For instance, an embodiment may include 56 probes for each SNP: the 8 probes corresponding to the polymorphic position at the center or 0 position and 8 probes for the polymorphic position at each of the following positions −4, −2, −1, +1, +3 and +4 relative to the central or 0 position.

Further details regarding the design and use of probes and probe sets are provided in U.S. Pat. No. 6,188,783; in PCT Application Serial No. PCT/US01/02316, filed Jan. 24, 2001; in U.S. patent applications Ser. Nos. 09/721,042, 09/718,295, 09/745,965, and 09/764,324; and in U.S. Provisional Patent Application Serial No. 60/470,475, titled “Methods for Genotyping Polymorphisms in Humans”, filed May 14, 2003, all of which are hereby incorporated herein by reference in their entireties for all purposes.

Probe Array Spotter/Synthesizer 150: Some embodiments of high throughput probe array analysis system 100 may work in association with probe array spotter/synthesizer 150. An illustrative embodiment of a microarray spotting or synthesizing instrument is presented in FIG. 1 as probe array spotter/synthesizer 150. In the illustrative example of FIG. 1, probe array 140 is produced by spotter/synthesizer 150 which receives instructions from user computer 130A. In the present example probe array 140 could be a spotted probe array or a synthesized probe array. Methods for producing synthesized or spotted arrays are described above in reference to probe array 140.

Some embodiments of spotter/synthesizer 150 are enabled to produce a plurality of probe arrays in a high throughput fashion. For example, spotter/synthesizer 150 may produce a plurality of probe arrays 140 simultaneously. For instance, some probe arrays may be produced in parallel where spotter/synthesizer 150 separately produces a plurality of arrays on individual glass slides, or other type of substrate. Alternatively, probe arrays 140 may be produced by various methods of probe deposition onto a single substrate that then may be diced or divided into individual implementations of probe array 140. In the present example, some implementations of spotter/synthesizer 150 may produce a number of probe arrays that is user selectable via computer 130A or alternatively it may be a predefined value stored and executed via computer 130A.

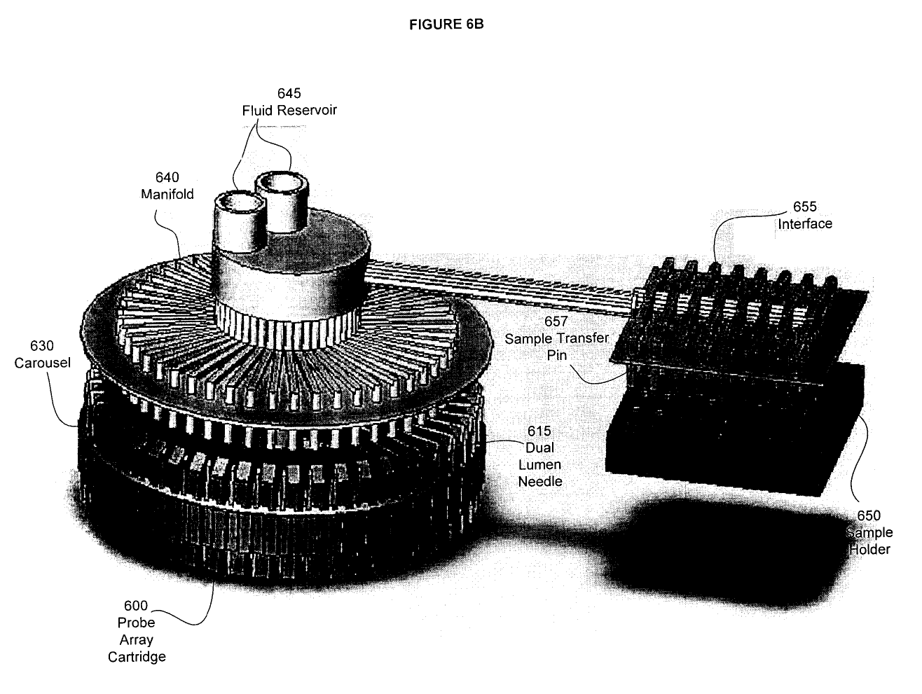

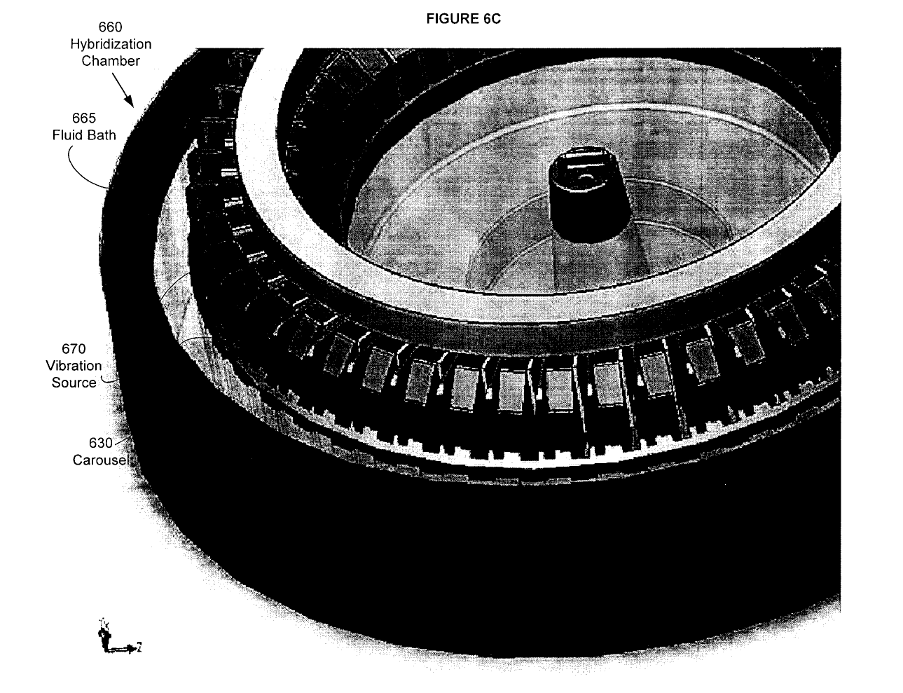

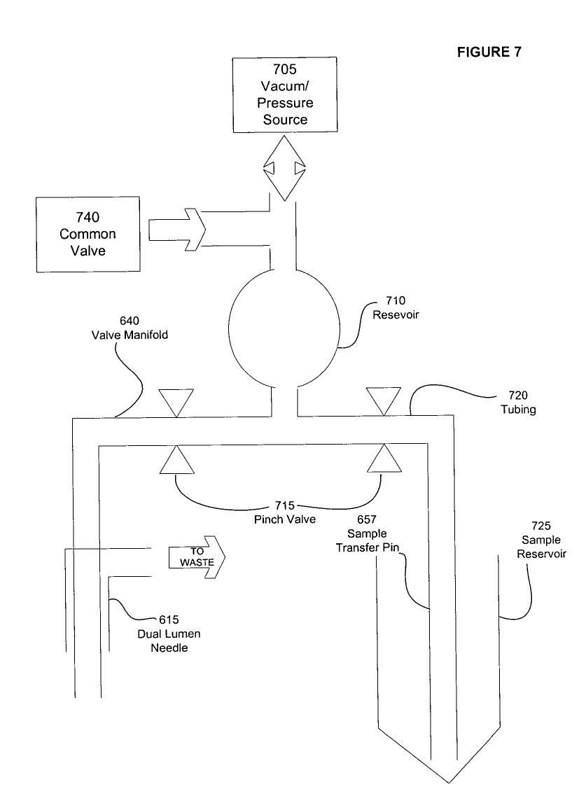

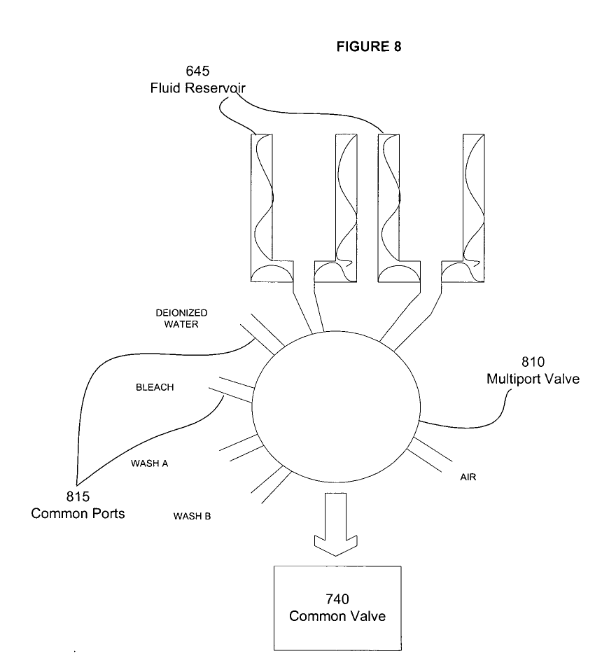

Additionally, some embodiments of spotter/synthesizer 150 may be enabled to house each implementation of probe array 140 in a cartridge or housing, such as the illustrative example of probe array cartridge 600 presented in FIG. 6. Illustrated in FIG. 6 is a “cutaway” view of cartridge 600 showing probe array 140 positioned in probe array pocket 620. Probe array pocket 620 may include a chamber that is in fluid communication with inlet channel 623 and outlet channel 627, and be of sufficient dimension as to allow fluid to flow over probe array 140 coming in contact with the probes disposed thereupon. Some embodiments of probe array pocket 620 may include fiducial features such as ridges, folds, dimples, posts, or other feature that may create turbulence in a liquid flow. It may be desirable in many implementations to create turbulent flow of fluids over probe array 140 so that the probability of probe and target contact is optimized. Additional methods of optimization may also include the formation of a bubble of air or other appropriate gas. Such a bubble may move relative to cartridge 600 in response to orientation change of cartridge position thus creating fluid movement in response. For example, an air bubble of a desired size may be reproducibly created by trapping air in air pocket 615 and introducing a fluid via inlet channel 623 while cartridge 600 is oriented vertically with air pocket 615 being the highest point. Liquid transfer aperture 610 may be capped or otherwise reversibly blocked to the passage of fluid flow so that the orientation of cartridge 600 may be changed without fluid loss.

Some embodiments of cartridge 600 may also include liquid transfer aperture 610 that is enabled to accept an implementation of dual lumen needle 615. For example, liquid transfer aperture 610 may be so dimensioned to correspond to the outer dimension of dual lumen needle 615 so that when dual lumen needle 615 interfaces with cartridge 600 a passive seal may be created. Some implementations may also include an O-ring, septa, or other type of implementation known to those of ordinary skill, to assist in the creation of a seal that is resistant to the passage of liquids. Similarly, inlet channel 623 may be so dimensioned to correspond to the outer dimension of inner lumen 619 to create a passive seal resistant to the passage of fluids.

Preferred embodiments of dual lumen needle 615 may be enabled to reversibly introduce and remove liquids from probe array cartridge 600 in a controlled manner. For example, some implementations may include the introduction of fluids via inner lumen 619, and the removal of liquids via outer lumen 617. The introduction of fluids may be accomplished using a positive pressure from the source of fluids such as lumen 619 that may also, in some embodiments, be assisted by the creation of a negative pressure from the outlet of fluids such as lumen 617. Similarly, fluids may be removed from cartridge 600 by the creation of negative pressure at the outlet. Some embodiments may also include the introduction of air or other type of gas via lumen 619 to assist in purging probe array pocket 620 of all liquids. In the present example, positive and negative pressure may be created by various means known to those of ordinary skill in the related art.

Additionally, fluid control operations enabled by dual lumen needle 615 may serve additional purposes such as, for instance, “pulsing” fluid in probe array pocket 620 by creating an alternating pressure differential between outlet channel 627 and inlet channel 623. Pulsing fluid may serve a similar purpose of optimizing probe-target contact in many implementations as described above in reference to fiducial features. Such a pressure differential may, for example, be created by creating positive pressure through inlet channel 623 and negative pressure through outlet channel 627. In the present example, the pressure differential may then be reversed creating a negative pressure through inlet channel 623 and positive pressure through outlet channel 627, continuing the alternation through a desired number of iterations.

Some embodiments of dual lumen needle 615 may also be enabled to sense the presence/absence or composition of liquids within cartridge 600. For example, as those of ordinary skill in the related art will appreciate, the conductivity of a fluid may be measured using inner lumen 619 and outer lumen 617 as probes. If no liquid is present no conductivity may be measured. If a fluid is present, a conductivity reading may be measured that may also be indicative of the type of fluid based, at least in part, upon the level of conductivity.

Spotter/synthesizer 150 may also work with an autoloader implementation such as autoloader 143 or other type of instrument such as for instance, one or more types of robotic device known to those in the art for transporting slides, trays, plates, cartridges, or other similar type of article. One embodiment of autoloader 143 or device may automatically remove one or more spotted or synthesized probe arrays from spotter/synthesizer 150 and load them into a carousel or magazine such as, for instance, carousel 630 as illustrated in FIG. 6B that may then be ready for use in a high throughput format. In an alternative embodiment, spotter/synthesizer 150 may perform the functions of placing the probe arrays in the carousel or magazine. In the two embodiments described above, spotter/synthesizer 150 may be located remotely from high throughput probe array analysis system 100 where carousel 630 containing a plurality of probe arrays 140 may be transported to system 100 for processing and analysis. Alternatively, spotter/synthesizer 150 may be directly associated with system 100 so that the process of producing, processing, and analyzing probe arrays 140 may be accomplished as a seamless process. For example, autoloader 143 may also act as an intermediary between spotter/synthesizer 150 and high throughput probe array analysis system 100.

Some embodiments of spotter/synthesizer 150 may include systems and methods for reading and/or assigning barcode identifiers or other type of identifier such as, for instance, other means of electronic or optically based identification such as magnetic strips, what are referred to by those of ordinary skill in the related art as radio frequency identification (RFID), or other means of encoding information in a machine readable format. For example, spotter/synthesizer 150 may apply a barcode associated with a barcode identifier to each implementation of probe array 140 using techniques known to those of ordinary skill in the related art such as, for instance, affixing a label, printing, or other type of method for labeling. In the present example, the barcode identifier may be comprised of one or more elements that could include unique identifiers, probe array type, lot number, expiration date, user identifiers, one or more experimental parameters, or other type of associated information.

In some embodiments, computer 130A may assign one or more elements of a barcode identifier for each implementation of probe array 140 such as, for instance, a unique identifier, and create database records, experiment files, or other type of data structure that may contain the barcode identifiers, one or more elements of the barcode identifiers, and associated information that may be retrieved based, at least in part, upon one or more of the elements of the barcode identifiers. Computer 130A may then forward the database records and/or experiments files to a LIMS system, illustrated in FIG. 1 as LIMS 120, or other remote server or storage device. Alternatively, computer 130A may forward the database records and/or experiment files to computer 130B via network 125, or store the database records and/or experiment files on computer readable storage media such as a floppy disk, CD-ROM, or other type of removable storage.

Additionally, in some embodiments computer 130A may assign one or more identifiers to carousel 630 or magazine that could for instance relate to all probe arrays used in a particular set of experiments. The identifiers may include those that are similarly described above with respect those associated with probe array 140. For example, spotter/synthesizer 150 produces a plurality of probe arrays 140 and arranges them in carousel 630. Each implementation of probe array 140 has an associated identifier and barcode label affixed to it. The carousel identifier may be associated with experiment information and/or data and contain one or more references to each probe array identifier associated with an experiment. Additionally, the carousel identifier may be stored in an experiment data file or one or more database records.

Additional examples of a high throughput probe array spotting system is provided in Patent Cooperation Treaty Application Serial No. PCT/US02/13883, filed May 2, 2002, incorporated by reference above.

Those of ordinary skill in the related art will appreciate that the instruments and functions described with respect to Probe array spotter/synthesizer 150 are for the purpose of illustration only and should not be considered limiting in any way. For example, the described functions need not be performed by a single instrument but rather may be performed by a plurality of instruments performing various steps that may occur at various points in time. Similarly in the case of a plurality of instruments, the instruments need not be located in close proximity to one another but rather one or more may be located remotely from a first instrument.

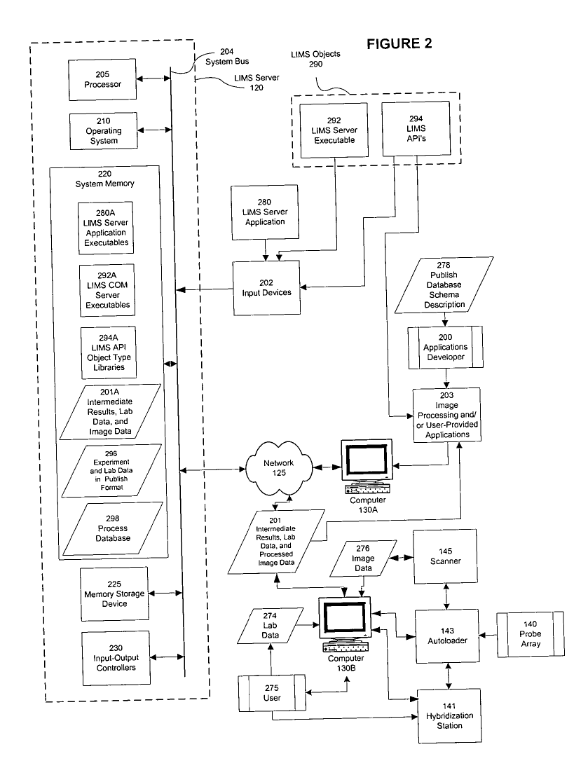

Probe Set Identifiers: Probe-set identifiers typically come to the attention of a user, represented by user 275 of FIGS. 2, 3, and 5, as a result of experiments conducted on probe arrays. For example, user 275 may select probe-set identifiers that identify microarray probe sets capable of enabling detection of the expression of mRNA transcripts from corresponding genes or EST's of particular interest, and SNP's or nucleotide base composition associated with genomic DNA. As is well known in the relevant art, an EST is a fragment of a gene sequence that may not be fully characterized, whereas a gene sequence generally is complete and fully characterized. The word “gene” is used generally herein to refer both to full size genes of known sequence and to computationally predicted genes. In some implementations, the specific sequences detected by the arrays that represent these genes or EST's may be referred to as, “sequence information fragments (SIF's)” and may be recorded in what may be referred to as a “SIF file.” In particular implementations, a SIF is a portion of a consensus sequence that has been deemed to best represent the mRNA transcript from a given gene or EST. The consensus sequence may have been derived by comparing and clustering EST's, and possibly also by comparing the EST's to genomic sequence information. A SIF is a portion of the consensus sequence for which probes on the array are specifically designed. With respect to the operations of experiment manager 520 of the particular implementation described herein, it is assumed with respect to some aspects that some microarray probe sets may be designed to detect the expression of genes based upon sequences of EST's.

As was described above, the term “probe set” refers in some implementations to one or more probes from an array of probes on a microarray. For example, in an Affymetrix® GeneChip® probe array, in which probes are synthesized on a substrate, a probe set may consist of 30 or 40 probes, half of which typically are controls. These probes collectively, or in various combinations of some or all of them, are deemed to be indicative of the expression of a gene or EST, and the presence or absence of a particular SNP or nucleotide base at a particular sequence position of genomic DNA. In a spotted probe array, one or more spots may similarly constitute a “probe set.”

The term “probe-set identifiers” is used broadly herein in that a number of types of such identifiers are possible and may be included within the meaning of this term in various implementations. One type of probe-set identifier is a name, number, or other symbol that is assigned for the purpose of identifying a probe set. This name, number, or symbol may be arbitrarily assigned to the probe set by, for example, the manufacturer of the probe array. A user may select this type of probe-set identifier by, for example, highlighting or typing the name. Another type of probe-set identifier as intended herein is a graphical representation of a probe set. For example, dots may be displayed on a scatter plot or other diagram wherein each dot represents a probe set, as described for example in U.S. Pat. No. 6,420,108, which is hereby incorporated herein in its entirety for all purposes. Typically, the dot's placement on the plot represents the intensity of the signal from hybridized, tagged, targets (as described in greater detail below) in one or more experiments. In these cases, a user may select a probe-set identifier by clicking on, drawing a loop around, or otherwise selecting one or more of the dots. In another example, user 275 may select a probe-set identifier by selecting a row or column in a table or spreadsheet that correlates probe sets with accession numbers and other genomic information.

Yet another type of probe-set identifier, as that term is used herein, includes a nucleotide or amino acid sequence. For example, it is illustratively assumed that a particular SIF is a unique sequence of 500 bases that is a portion of a consensus sequence or exemplar sequence gleaned from EST and/or genomic sequence information. It further is assumed that one or more probe sets are designed to represent the SIF. A user who specifies all or part of the 500-base sequence thus may be considered to have specified all or some of the corresponding probe sets. Alternatively, each SNP in a particular sequence is assumed to be located at a specific sequence location and flanked by sequence regions that may be used to help identify the particular SNP by a probe set.

As a further example with respect to a particular implementation, a user may specify a portion of the 500-base sequence noted above, which may be unique to that SIF, or, alternatively, may also identify another SIF, EST, cluster of EST's, consensus sequence, and/or gene or protein. The user thus specifies a probe-set identifier for one or more genes or EST's. In another variation, it is illustratively assumed that a particular SIF is a portion of a particular consensus sequence. It is further assumed that a user specifies a portion of the consensus sequence that is not included in the SIF but that is unique to the consensus sequence or the gene or EST's the consensus sequence is intended to represent. In that case, the sequence specified by the user is a probe-set identifier that identifies the probe set corresponding to the SIF, even though the user-specified sequence is not included in the SIF. Parallel cases are possible with respect to user specifications of partial sequences of EST's and genes or EST's, as those skilled in the relevant art will now appreciate.

A further example of a probe-set identifier is an accession number of a gene or EST, and SNP identification number. Gene and EST accession numbers and SNP identification numbers are publicly available. A probe set may therefore be identified by the accession number or numbers of one or more EST's and/or genes or SNP identification number corresponding to the probe set. The correspondence between a probe set and EST's or genes may be maintained in a suitable database from which the correspondence may be provided to the user. Similarly, gene fragments or sequences other than EST's may be mapped (e.g., by reference to a suitable database) to corresponding genes or EST's for the purpose of using their publicly available accession numbers as probe-set identifiers. For example, a user may be interested in product or genomic information related to a particular SIF that is derived from EST-1 and EST-2. The user may be provided with the correspondence between that SIF (or part or all of the sequence of the SIF) and EST-1 or EST-2, or both. To obtain product or genomic data related to the SIF, or a partial sequence of it, the user may select the accession numbers of EST-1, EST-2, or both.

Additional examples of probe-set identifiers include one or more terms that may be associated with the annotation of one or more gene, EST, or SNP sequences, where the gene, EST, or SNP sequences may be associated with one or more probe sets. For convenience, such terms may hereafter be referred to as “annotation terms” and will be understood to potentially include, in various implementations, one or more words, graphical elements, characters, or other representational forms that provide information that typically is biologically relevant to or related to the gene, EST, or SNP sequence. Associations between the probe-set identifier terms and gene, EST, or SNP sequences may be stored in a database such as a local genomic database, or they may be transferred from one or more remote databases. Examples of such terms associated with annotations include those of molecular function (e.g. transcription initiation), cellular location (e.g. nuclear membrane), biological process (e.g. immune response), tissue type (e.g. kidney), or other annotation terms known to those in the relevant art.

Hybridization station 141: Illustrated in FIG. 1 is hybridization station 141. In a preferred embodiment station 141 implements procedures for hybridizing one or more experimental samples to one or more probe arrays in a high throughput fashion.

As previously discussed, probe array 140 may be disposed upon some surface, such as a glass slide. Station 141 could immerse the exposed probe array in a specified volume of sample. Alternatively the sample could be applied to the surface of the probe array using some means of liquid retention.

Alternatively, a preferred embodiment includes probe array 140 enclosed in a housing or cartridge such as cartridge 600. In some embodiments, a plurality of cartridges 600 may be placed in carousel 630, as previously described in reference to spotter/synthesizer 150. In some implementations, each probe array cartridge 600 may be oriented in a vertical orientation with respect to carousel 630. For example, carousel 630 may hold up to 32, 48, 100 or more implementations of cartridge 600 depending, at least in part, upon the high-throughput application.

Illustrated in FIG. 6B are elements of station 141 that could, for instance, be enabled to introduce a sample, washes, buffers, stains, or other types of fluid into cartridge 600 through one or more specialized ports such as aperture 610. The illustrative elements of the example presented in FIG. 6B that may be enabled to automatically introduce and remove fluids from cartridge 600 without user intervention include sample holder 650, interface 655, fluid reservoir 645, and manifold 640. Executables 399 directs station 141 to add a specified volume of a particular sample to an associated implementation of probe array cartridge 600. Station 141 removes the specified volume of sample from a reservoir positioned in sample holder 650 via one of sample transfer pins 657 pin. In the present example, sample holder 650 may be thermally controlled in order to maintain the biological integrity of the samples contained in the reservoirs. The term “reservoir” as used herein could include a vial, tube, bottle, or some other container suitable for holding volumes of liquid. Sample holder 650 or a series of holders 650 may include a tray, carousel or magazine and may additionally include one or more unique barcode or other type identifiers. Also in the present example, station 141 may employ a vacuum/pressure source, valves, and means for fluid transport known to those of ordinary skill in the related art.

Continuing the example from above, station 141 interfaces with each of probe array cartridges 600 by moving each dual lumen needle 615 in a first direction towards its particularly associated probe array cartridge 600. Each dual lumen needle 615 enters its particularly associated probe array cartridge 600 via liquid transfer aperture 610 until dual lumen needle 615 and probe array cartridge 600 are fully engaged. In the present example, station 141 may simultaneously or in a sequential fashion remove a specified aliquot of sample from each reservoir disposed in sample holder 650 and deliver each sample to a specified probe array cartridge 600, via tubing, that fluidically connects interface 655 with manifold 640 and dual lumen needle 615.

Dual lumen needle 615 may remove used or waste fluids from cartridge 600 by, for instance, creating a negative pressure or vacuum through outer lumen 617. Removal may, in some embodiments be aided by creating a positive pressure of gas or other fluids through inner lumen 319 that may assist in “flushing” the fluid to be removed from cartridge 600. Removed fluids may be stored in a waste reservoir (not shown) or alternatively may be expelled from station 141 into another waste receptacle or drain.

As those of ordinary skill in the related art will appreciate, the sample content of each reservoir within sample holder 650 is known so that executables 399 may associate an experimental sample with a particular probe array cartridge 600. Station 141 may also provide one or more detectors associated with sample holder 650 to indicate to executables 399 when a reservoir is present or absent. The detectors could, for instance include leaf springs, optical sensors tripped by the introduction of the sample holder or reservoir, or other methods for detecting the presence of objects. Additionally, the one or more detectors may include one or more implementations of a barcode reader enabled to identify each reservoir using an associated barcode identifier. For example, executables 399 may consult a data file, or other type of data structure, including an experiment data file, associated with a reservoir holder identifier. The data file may contain information such as the location information of a particular experimental sample. Executables 399 instructs station 141 to remove a specified volume of sample from the location specified in the data file for transfer to the appropriate probe array cartridge.

Alternatively, some embodiments of station 141 may be enabled to transfer a sample using a pin or needle that removes a sample from the reservoir and directly transfers the sample to probe array 140.

As previously discussed with respect to probe array cartridge 600, some embodiments of station 141 may include one or more detection systems enabled to detect the presence and identity of a fluid within probe array cartridge 600. For example, one possible type of detection system may employ what those of ordinary skill in the related art refer to as conductivity measurements. As those of ordinary skill in the related art will appreciate, a conductivity measurement includes a measure of conductance that refers to the ability of a material or fluid to conduct electricity. A variety of factors may affect conductivity, such as the amount of salts or other materials in a liquid, for instance a high salt water solution will be more conductive than distilled water with no mineral content. Solutions can have characteristic conductivity's that may be used for identification purposes. In the present example, station 141 may employ dual lumen needle 615 to measure the conductivity at various points in time. The conductivity measurements may be communicated to one or more elements of probe array analysis executables 399A that may in turn respond by instructing station 141 to perform one or more operations such as, for instance, add a specified fluid, remove fluid, or other type of hybridization or processing operation.

In some embodiments, one or more features may be built directly into probe array cartridge 600 that station 141 may employ for conductivity measurement. For example, probe array cartridge 600 may include on or more electrically conductive elements that may be arranged such that if a minimum volume of fluid is present in cartridge 600 the fluid is then in contact with both of the conductive elements.

Some embodiments of station 141 may provide an environment that promotes the hybridization of a biological target contained in a sample to the probes of the probe array. Some environmental conditions that affect the hybridization efficiency could include temperature, gas bubbles, agitation, oscillating fluid levels, or other conditions that could promote the hybridization of biological samples to probes. For example, station 141 may include hybridization chamber 660, as illustrated in FIG. 6C, that includes fluid bath 665 for temperature control. In the present example, executables 399A may control the temperature of fluid bath 665 using methods known to those of ordinary skill in the related art and additionally the temperature may be fluctuated according to parameters that may, for instance, be defined in experiment data 550 or parameter data 555.

Other environmental conditions that station 141 may provide may include a means to improve mixing of fluids within cartridge 600. For example, ultrasonic agitation may provide vibration and fluidic movement within cartridge 600 that may improve the efficiency of hybridization of the sample to probe array 140. Returning to the illustrative example of FIG. 6C, carousel 630 with one or more cartridges 600 may be immersed in a fluid bath 665. Additionally, there may be one or more ultrasonic agitation sources such as, for instance, vibration source 670. In the present example, there may be an implementation of source 670 associated with each cartridge 600, and/or with each partition of carousel 630 that may, for instance promote an even dispersal of the agitation over each probe array.

Additionally as previously described with respect to cartridge 600, station 141 may provide air or gas to cartridge 600 to promote the formation of a bubble. For example, the gas bubble may include ambient air or other type of gas that improves sample hybridization.

FIGS. 7 and 8 provide simplified graphical examples of one possible embodiment for providing fluidic and/or gas connection of one or more of the previously described elements. Some elements include vacuum/pressure source 705, common valve 740, reservoir 710, tubing 720, sample reservoir 725, pinch valve 715, multiport valve 810, and common ports 815. In the present example common valve 740 may be an intermediate between the elements presented in FIG. 7 and the elements of FIG. 8. In some implementations, executables 399A may instructs valve 740 to open or close depending upon the mode of operation such as rinsing with washes or buffers, staining, or washing and/or disinfecting the elements with deionized water and/or bleach. Executables 399A may similarly control multiport valve 810 to allow the passage of a particular fluid or gas that is appropriate for the particular operation or protocol. Continuing the present example, common ports 815 may each be in fluidic connection with sources of fluid or gas that may be located outside of station 141. Additional sources may also include one or more fluid reservoirs 645 that could be integral elements of station 141. Fluid reservoir 645 may, in some implementations, provide executables 399A with additional control such as, for instance, thermal control of fluids contained therein.

Still continuing the above example, reservoir 710 may include a chamber or space so dimensioned to provide a holding area for an aliquot of sample or other type of liquid. For example, in some implementations the volume of space in reservoir 710 may be large enough to allow bubbles to escape without losing or removing liquid from reservoir 710. Pinch valves 715 may also be provided to provide executables 399A control of fluid passage. Valves 715 may be enabled to fully stop fluid flow by closing and thereby “pinching” tubing 720 closed. For example, tubing 720 may include soft tubing such as latex, or other type of soft tubing that is sufficiently pliable and durable so that valves 715 may efficiently control fluid flow without damage to tubing 720.

In addition, metering pumps may be associated with one or more fluid sources and used to customize what those of ordinary skill in the related art may refer to as the “stringency” of the wash or other type of solution for a particular assay. The term “stringency” as used herein generally refers to the reactions conditions for annealing nucleic acid strands to one another that include parameters such as temperature, salt concentration, and/or PH where a high stringency refers to the pairing of nucleic acid sequences with perfect sequence identity and low stringency refers to pairing or annealing of strands with some degree of mismatch pairing between sequences. This allows a limited number of stringent solutions to create any stringency between the stringencies of the solutions present.

Embodiments of station 141 may also perform what those of ordinary skill in the related art may refer to as post hybridization operations such as, for instance, washes with buffers or reagents, water, labels, or antibodies. For example, staining may include introducing molecules with fluorescent tags that selectively bind to the biological molecules or targets that have hybridized to probe array 140. In the present example, one or more fluorescently tagged molecules may bind to each probe/target pair where each additional fluorescent molecule that binds increases the intensity of emitted light during scanning. Also, the process of staining could include exposure of the hybridized probe array to molecules with fluorescent tags with different characteristics such as molecules that selectively bind to a specific hybridized probe target pairs, or a variety of fluorescent tags with different excitation and emission properties. For instance, a first fluorescent tag may become excited when exposed to a first wavelength of light and emit light at a second wavelength. A second fluorescent tag may be in close enough proximity to the first fluorescent tag and become excited by the second wavelength of light, and emit a fourth wavelength of light.

Additional post-hybridization operations may, for example, include the introduction of what is referred to as a non-stringent buffer into cartridge 600 to preserve the integrity of the hybridized array.

Some implementations of station 141 allow for interruption of operations to insert or remove probe arrays, samples, reagents, buffers, or any other materials. After interruption, station 141 may conduct a scan of some or all identifiers associated with probe arrays, samples, carousels or magazines, user input identifiers, or other identifiers used in the automated process. For example, a user may wish to interrupt that process conducted by station 141 to remove a tray of samples and insert a new tray. The user must first input a user identifier before interruption is allowed. The interruption is communicated to the user by a variety of methods, and the user performs the desired tasks. The user inputs a command for the resumption of the process that begins with station 141 scanning all available barcode identifiers. Executables 399A determines what has been changed, and makes the appropriate adjustments to procedures and protocols.

Station 141 may also perform operations that do not act directly upon a probe array. Such functions could include the management of fresh versus used reagents and buffers, experimental samples, or other materials utilized in hybridization operations. Additionally, station 141 may include features for leak control and isolation from systems that may be sensitive to exposure to liquids. For example, a user may load a variety of experimental samples into station 141 that have unique experimental requirements. In the present example the samples may have barcode labels with unique identifiers associated with them. The barcode labels could be scanned with a hand held reader or alternatively station 141 could include an internal reader. Alternatively, other means of electronic identification could be used. The user may associate the identifier with the sample and store the data into one or more data files that for example could include experiment data 50. The sample may also be associated with a specific probe array type that is similarly stored.

Autoloader 143: Illustrated in FIG. 1 is autoloader 143 that is an example of one possible embodiment of an automatic cartridge loader used in conjunction with a scanner and hybridization station. Further illustrations of the present example are provided in FIGS. 2-5.

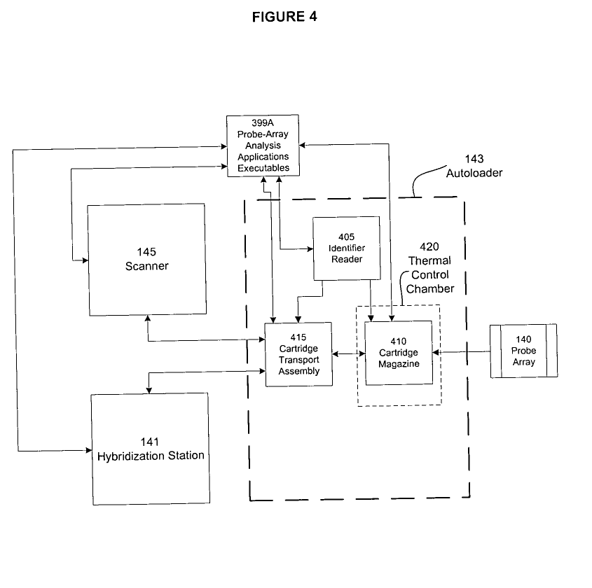

Autoloader 143 consists of a number of components, illustrated in FIG. 4 as cartridge magazine 410, cartridge transport assembly 415, and thermal control chamber 420. Some features of the illustrated implementation include the preservation of biological integrity of the probe arrays for up to sixteen hours by controlling the array storage environment. Also, in the event of a power failure or error condition that prevents scanning, autoloader 143 will indicate the failure to the user and maintain storage temperature for all probe arrays through the use of an uninterruptable power supply system. For example, a power failure or other error may be communicated to the user by one or more methods that could include audible/visual alarm indicators from autoloader 143, a graphical user interface such as GUI 182 displayed to the user on a local or remote workstation, automated paging system, or other means of automated communication. In the present example, the uninterruptable power supply system could be located internally to autoloader 143, or remotely. The internal or remote power supply system could also support one or more other systems such as scanner 145 or hybridization station 141.

Other features of the illustrated implementation include pre-heating the probe arrays to the same temperature as the internal environment of scanner 145 prior to transport to the scanner. Similarly, thermal control chamber 420 could bring probe array 140 to the appropriate hybridization temperature prior to loading into hybridization station 141. When autoloader 143 removes the probe array from either scanner 145 or hybridization chamber 141, thermal control chamber 420 may warm or cool the probe array to a preferred temperature in order to preserve biological integrity. An additional feature of the illustrated implementation allows for interruption of operations to introduce a probe array cartridge directly into scanner 145 for immediate scanning, or to load additional probe array cartridges at any time into autoloader 143.

In a preferred embodiment autoloader 143 serves to provide automated cartridge loading/unloading to both hybridization station 141 and scanner 145. In the present embodiment, autoloader 143 may be equipped with a barcode reader, illustrated in FIG. 4 as identifier reader 405. Alternatively, identifier reader 405 could include other means of electronic identification such as magnetic strips, what are referred to by those of ordinary skill in the related art as radio frequency identification (RFID), or other means of encoding information in a machine readable format as previously described with respect to spotter/synthesizer 150. In the presently described preferred implementation, reader 405 scans a barcode label affixed to a probe array cartridge and forwards the barcode identifier to executables 399. For example, a user loads autoloader 143 with a plurality of probe array cartridges. The probe array cartridges may or may not be of the same probe array type. Executables 399 instructs autoloader 143 to load a specific type of probe array into hybridization station 141. Identifier reader 405 scans the barcode label of a probe array cartridge that may be present in a cartridge transfer position. If executables 399 determines that data encoded in the barcode identifier indicates the appropriate probe array type, autoloader 143 loads the probe array cartridge into station 141. Otherwise, autoloader 143 advances cartridge magazine 410 until another probe array cartridge is present in the cartridge transfer position. In the present example, the barcode identifier may include the probe array type as well as other data. Alternatively, the barcode identifier may point to data that includes the probe array type.

As illustrated in FIG. 4, identifier reader 405 may be enabled to scan barcode labels of cartridges in either cartridge transport assembly 415, or cartridge magazine 410. Alternatively, scanner 145 and/or hybridization station 143 may have additional implementations of reader 405 incorporated with them. For example, some embodiments could include a barcode reader housed within scanner 145 that scans a barcode label immediately prior to scanning the hybridized probe array. Similarly, hybridization station 143 houses a barcode reader that scans the barcode label immediately prior to performing hybridization operations. Both embodiments communicate with executables 399 to obtain the appropriate parameters and protocols for the specific probe array.

The features described above provide equipment and techniques to transfer cartridges from a temperature controlled environment into the scanner or hybridization station in an organized and efficient manner, and to return the cartridges to the temperature controlled environment following imaging or hybridization. Optimal temperatures for storing cartridges may vary, but typically include temperatures preferably ranging from 2° C. to 15° C.

Additional examples are described in U.S. Provisional Patent Application Serial Nos. 60/217,246, titled “CARTRIDGE LOADER AND METHODS”, filed Jul. 10, 2000; 60/364,731, titled “System, Method, and Product for High-Resolution Scanning of Biological Materials”, filed Mar. 15, 2002; 60/396,457, titled “High-Throughput Mircoarray Scanning System and Method”, filed Jul. 17, 2002; U.S. patent application Ser. No. 10/389,194, titled “System, Method and Product for Scanning of Biological Materials”, filed Mar. 14, 2003; and U.S. Pat. Ser. No. 6,511,277 titled “CARTRIDGE LOADER AND METHODS”, each of which is hereby incorporated herein by reference in their entireties for all purposes.

Scanner 145: Scanner 145 of this example provides an image of hybridized probe-target pairs by detecting fluorescent, radioactive, or other emissions; by detecting transmitted, reflected, or scattered radiation; by detecting electromagnetic properties or characteristics; or by other techniques. These processes or techniques may generally and collectively be referred to hereafter for convenience simply as involving the detection of “emissions.” Various detection schemes are employed depending on the type of emissions and other factors. A typical scheme employs optical and other elements to provide excitation light and to selectively collect the emissions. Also generally included are various light-detector systems employing photodiodes, charge-coupled devices, photomultiplier tubes, or similar devices to register the collected emissions. For example, a scanning system for use with a fluorescent label is described in U.S. Pat. No. 5,143,854, incorporated by reference above. Illustrative scanners or scanning systems that, in various implementations, may include scanner 145 are described in U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,252,236; in PCT Application PCT/US99/06097 (published as WO99/47964); in U.S. patent applications, Ser. Nos. 10/389,194, 10/063,284, 09/683,216, 09/683,217, 09/683,219, 09/681,819, and 09/383,986; and in U.S. Provisional Patent Applications Serial Nos. 60/364,731, 60/396,457, and 60/286,578, each of which is hereby incorporated herein by reference in its entirety for all purposes.

Scanner 145 of this non-limiting example provides data representing the intensities (and possibly other characteristics, such as color) of the detected emissions, as well as the locations on the substrate where the emissions were detected. The data typically are stored in a memory device, such as system memory 320 of user computer 130, in the form of a data file. One type of data file, such as image data 276 shown in FIG. 2 that could for example be in the form of a “*.cel” file generated by Microarray Suite or GCOS software available from Affymetrix, Inc., typically includes intensity and location information corresponding to elemental sub-areas of the scanned substrate. In the illustrated example of FIG. 2, computer 130B could receive data 276 and generate a *.cel file, alternatively scanner 145 could generate the *.cel file. The term “elemental” in this context means that the intensities, and/or other characteristics, of the emissions from this area each are represented by a single value. When displayed as an image for viewing or processing, elemental picture elements, or pixels, often represent this information. Thus, for example, a pixel may have a single value representing the intensity of the elemental sub-area of the substrate from which the emissions were scanned. The pixel may also have another value representing another characteristic, such as color. For instance, a scanned elemental sub-area in which high-intensity emissions were detected may be represented by a pixel having high luminance (hereafter, a “bright” pixel), and low-intensity emissions may be represented by a pixel of low luminance (a “dim” pixel). Alternatively, the chromatic value of a pixel may be made to represent the intensity, color, or other characteristic of the detected emissions. Thus, an area of high-intensity emission may be displayed as a red pixel and an area of low-intensity emission as a blue pixel. As another example, detected emissions of one wavelength at a particular sub-area of the substrate may be represented as a red pixel, and emissions of a second wavelength detected at another sub-area may be represented by an adjacent blue pixel. Many other display schemes are known. Various techniques may be applied for identifying the data representing detected emissions and separating them from background information. For example, U.S. Pat. No. 6,090,555, and U.S. patent application Ser. No. 10/197,369, titled “System, Method, and Computer Program Product for Scanned Image Alignment” filed Jul. 17, 2002, which are both hereby incorporated by reference herein in their entireties for all purposes, describe various of these techniques. In a particular implementation, scanner 145 may identify one or more labeled targets. For instance, a sample of a first target may be labeled with a first dye (an example of what may more generally be referred to hereafter as a “label”) that fluoresces at a particular characteristic frequency, or narrow band of frequencies, in response to an excitation source of a particular frequency. A second target may be labeled with a second dye that fluoresces at a different characteristic frequency. The excitation source for the second dye may, but need not, have a different excitation frequency than the source that excites the first dye, e.g., the excitation sources could be the same, or different, lasers. The target samples may be mixed and applied to the probe arrays, and conditions may be created conducive to hybridization reactions, all in accordance with known techniques.

LIMS Server 120: FIG. 2 shows in greater detail a typical configuration of a server computer, such as server 120 of FIG. 1, coupled to a workstation computer via a network. For convenience, the server computer is referred to herein as LIMS server 120, although this computer may carry out a variety of functions in addition to those described below with respect to LIMS and LIMS-SDK software applications. Moreover, in some implementations any function ascribed to LIMS server 120 may be carried out by one or more other computers, and/or the functions may be performed in parallel by a group of computers. Network 125 may include a local area network, a wide area network, the Internet, another network, any combination thereof, or another computer system and network configuration.

Typically, LIMS server 120 is a network-server class of computer designed for servicing a number of workstations or other computer platforms over a network. However, server 120 may be any of a variety of types of general-purpose computers such as a personal computer, workstation, main frame computer, or other computer platform now or later developed. Server 120 typically includes known components such as a processor 205, an operating system 210, a system memory 220, memory storage devices 225, and input-output controllers 230. It will be understood by those skilled in the relevant art that there are many possible configurations of the components of server 120 and that some components that may typically be included are not shown, such as cache memory, a data backup unit, and many other devices. Similarly, many hardware and associated software or firmware components that may be implemented in a network server are not shown in FIG. 2. For example, components to implement one or more firewalls to protect data and applications, uninterruptable power supplies, LAN switches, web-server routing software, and many other components are not shown. Those of ordinary skill in the art will readily appreciate how these and other conventional components may be implemented.

Processor 205 may include multiple processors; e.g., multiple Intel Xeon® 700 MHz. As further examples, processor 205 may include one or more of a variety of other commercially available processors such as Pentium® processors from Intel, SPARC® processors made by Sun Microsystems, or other processors that are or will become available. Processor 205 executes operating system 210, which may be, for example, a Windows®-type operating system (such as Windows® 2000 with SP 1, Windows NT® 4.0 with SP6a) from the Microsoft Corporation; the Solaris operating system from Sun Microsystems, the Tru64 Unix from Compaq, other Unix® or Linux-type operating systems available from many vendors; another or a future operating system; or some combination thereof. Operating system 210 interfaces with firmware and hardware in a well-known manner, and facilitates processor 205 in coordinating and executing the functions of various computer programs that may be written in a variety of programming languages. Operating system 210, typically in cooperation with processor 205, coordinates and executes functions of the other components of server 120. Operating system 210 also provides scheduling, input-output control, file and data management, memory management, and communication control and related services, all in accordance with known techniques.

System memory 220 may be any of a variety of known or future memory storage devices. Examples include any commonly available random access memory (RAM), magnetic medium such as a resident hard disk or tape, an optical medium such as a read and write compact disc, or other memory storage device. Memory storage device 225 may be any of a variety of known or future devices, including a compact disk drive, a tape drive, a removable hard disk drive, or a diskette drive. Such types of memory storage device 225 typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 220 and/or the program storage device used in conjunction with memory storage device 225.

In some embodiments, a computer program product is described comprising a computer usable medium having control logic (computer software program, including program code) stored therein. The control logic, when executed by processor 205, causes processor 205 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 230 could include any of a variety of known devices for accepting and processing information from a user, whether a human or a machine, whether local or remote. Such devices include, for example, modem cards, network interface cards, sound cards, or other types of controllers for any of a variety of known input or output devices. In the illustrated embodiment, the functional elements of server 120 communicate with each other via system bus 204. Some of these communications may be accomplished in alternative embodiments using network or other types of remote communications.

As will be evident to those skilled in the relevant art, LIMS server application 280, as well as LIMS Objects 290 including LIMS servers 292 and LIMS API's 294 (described below), if implemented in software, may be loaded into system memory 220 and/or memory storage device 225 through one of input devices 202. LIMS server application 280 as loaded into system memory 220 is shown in FIG. 2 as LIMS server application executables 280A. Similarly, objects 290 are shown as LIMS server executables 292A and LIMS API object type libraries 294A after they have been loaded into system memory 220. All or portions of these loaded elements may also reside in a read-only memory or similar device of memory storage device 225, such devices not requiring that the elements first be loaded through input devices 202. It will be understood by those skilled in the relevant art that any of the loaded elements, or portions of them, may be loaded by processor 205 in a known manner into system memory 220, or cache memory (not shown), or both, as advantageous for execution.

LIMS Server Application 280: Details regarding the operations of illustrative implementations of application 280 are provided in U.S. patent applications Ser. Nos. 09/682,098 (hereby incorporated by reference herein in its entirety for all purposes) and 60/220,587, incorporated by reference above. It will be understood that the particular LIMS implementation described in this patent application is illustrative only, and that many other implementations may be used with LIMS objects 290 and other aspects of the present or alternative embodiments.

Application 280, and other software applications referred to herein, may be implemented using Microsoft Visual C++ or any of a variety of other programming languages. For example, applications may also be written in Java, C++, Visual Basic, any other high-level or low-level programming language, or any combination thereof.

As noted, certain implementations may be illustrated herein with respect to a particular, non-limiting, implementation of application 280, sometimes referred to as Affymetrix® LIMS. Full database functionality is intended to provide a data streaming solution and a single infrastructure to manage information from probe array experiments. Application 280 provides all the functionality of database storage and retrieval system for accessing and manipulating all system data. A database server provides an automated and integrated data management environment for the end user. All process data, raw data and derived data are stored as elements of the database, providing an alternative to a file-based storage mechanism. A database back end also provides integration of application 280 into a customer's overall information system infrastructure. Data is accessible through standard interfaces and can be tracked, queried, archived, exported, imported and administered.

Application 280 of the illustrated implementation, supports process tracking for a generic assay, adds enhanced administration functionality for managing GeneChip®, spotted array, and AADM data (GeneChip® data that has been published to the Affymetrix® Analysis Data Model standard), provides a full Oracle® database management software or SQL Server solution, supports publishing of genotype and sequence data, and provide a high level of security for the LIMS system. Aspects of illustrative publishing operations are described in U.S. patent application Ser. No. 09/683,982, which is hereby incorporated herein in its entirety for all purposes.

Application 280 of the illustrated example provides the following functionality. The Genenic assay, supported by process tracking from enhancements to data management. The processes include but are not limited to the following: sample definition, experiment setup, hybridization, scanning, grid alignment, cell intensity analysis, probe array analysis, and publishing. The generic assay supports multiple experiments per sample definition via a re-queuing process, multiple hybridization and scan operations for a single experiment, data re-analysis, and publishing to more than one database. The Process Database, either an Oracle or SQL Server DBMS (Database management system) solution, fully supported by enhancements to CasoAffy (COM Communication layer to the process database). The GeneInfo Database, where enhancements provide additional support for storing chromosome and probe sequence information about the biological item on the probe array. The AADM Database, a database that stores the published GeneChip data, where enhancements provide full support for either an Oracle or SQL server DBMS. Additional tables to AADM provide support for genotype data, and modifications to the publishing components include data load performance improvements as well as bi-directional communication with GeneChip during publishing operations. The Security Database, a LIMS security database provides a role-based security level that is integrated with the Windows NT® user authentication security. The security database supports role definition, functional access within a role and assigning NT groups and users to those roles. A role is a collection of users, which have a common set of access rights to GeneChip data. Roles are defined per server/database and a role member can be a member of multiple roles, where the software determines a user's access rights. A function is a pre-determined action that is common to all roles. Each role is defined by the functions it can and cannot perform. Functions explicitly describe the type of action that a member of the role can perform. The functions supported by a newly created role includes but is not limited to the following: read process data, delete process data, update process data, archive process data, assume ownership of process data, import, export process data, delete AADM data, create a AADM database, and maintaining roles. When a new user is added to a role they will have access privileges for their data and read only access privilege for other user data within the same role. All non-role members are denied all access privileges to role member's data. When application 280 of the illustrated implementation is installed, at least two roles are created: administration and system user. The installer of the system software is added as a user to the administration role and a selected Windows NT® group is added as a user to the system user role. The LIMS Manager, which is a stand-alone application that provides user management capabilities for GeneChip® Analysis Suite data and AADM databases within the LIMS system. These capabilities include but are not limited to the following: AADM database creation, publish data deletion, process data deletion, taking ownership of process data, archiving and de-archiving of process data, data export, data import, role management, filter based find, managing expression analysis parameter sets, and managing sample and experiment attribution templates.

The system supports high volume reference and research labs that wish to manage and track laboratory workflow and GeneChip data, including DAT, EXP, CEL, CHP, CMP files that have been generated outside of the LIMS system, via a database. End users of the system include scientists, database administrators and system administrators.

LIMS Objects 290: LIMS Objects 290 is an optional object oriented programmers interface into LIMS server application 280. In the illustrated embodiment, LIMS objects 290 includes a number of Application Programmers Interfaces (APIs), generally and collectively represented as LIMS API's 294, and a number of LIMS servers, generally and collectively represented as LIMS servers 292. LIMS servers 292 may be distributed as out of process executables (“exe's”) and LIMS API's 294 may be distributed as object type libraries (“tlb's”). It will be understood by those of ordinary skill in the art that various other distribution schemes and arrangements are possible.

LIMS Objects 290 typically may be used by an application developer (represented in FIG. 2 by applications developer 200) who wishes to integrate in-house or third-party software systems with a LIMS such as LIMS server application 280. For example, it is illustratively assumed that applications developer 200 works in an enterprise that employs LIMS server application 280 to manage data related to experiments conducted on probe arrays, which may include any type of probe arrays 140. It further is assumed for illustrative purposes that LIMS server application 280 is not a full-service system in that it does not provide functions such as laboratory process scheduling, sample management, instrument control, batch processing, and/or various data mining, processing, or visualization functions. Alternatively, application 280 may provide some or all of these functions, but applications developer 200 may wish to develop alternative or supplementary software applications to perform all or portions of any of these or other functions, and/or to integrate third-party software applications for these purposes. LIMS objects 290 provides developer 200 with tools to customize both the input of data into, and output of data from, LIMS server application 280.

LIMS objects 290 includes LIMS API's 294. API's 294, in a particular implementation of LIMS COM API's, includes the classes of loading list of objects, reading an object, updating/writing an object, deleting an object, processing data, creating AADM-compliant databases, and invocation of the analysis controller. API's are also included for objects, which are used by the previously listed classes.

Further aspects and implementations of the illustrated and other embodiments include the AADM database schema, which can be divided into four sub-schemas chip design, experiment setup, analysis results, and protocol parameters. The chip design sub-schema contains the overall chip description including the name, number of rows and columns of cells, the number of units, and a description of the units. The experiment setup sub-schema contains information on the chip used and the target that was applied. The analysis results sub-schema stores the results from any expression analysis. The protocol parameters sub-schema contains parameter information relating to target preparation, experiment setup, and chip analysis. The AADM database can be queried for analysis results, protocol parameters, and experiment setup in a similar fashion to the queries used by the Affymetrix® Data Mining Tool. The Affymetrix Data Mining Tool also uses a supplementary database called the Data Mining Info database, which stores user preferences, saved queries, frequently asked queries, and probe set lists. The Gene Info database, is used by Affymetrix® Microarray Suite or GCOS, stores probe set information such as descriptions of probe sets, sequences that are tiled on an expression array, and user defined annotations. It also stores lists of external database links that allow users to add links to internal/external databases, which could be public or private.

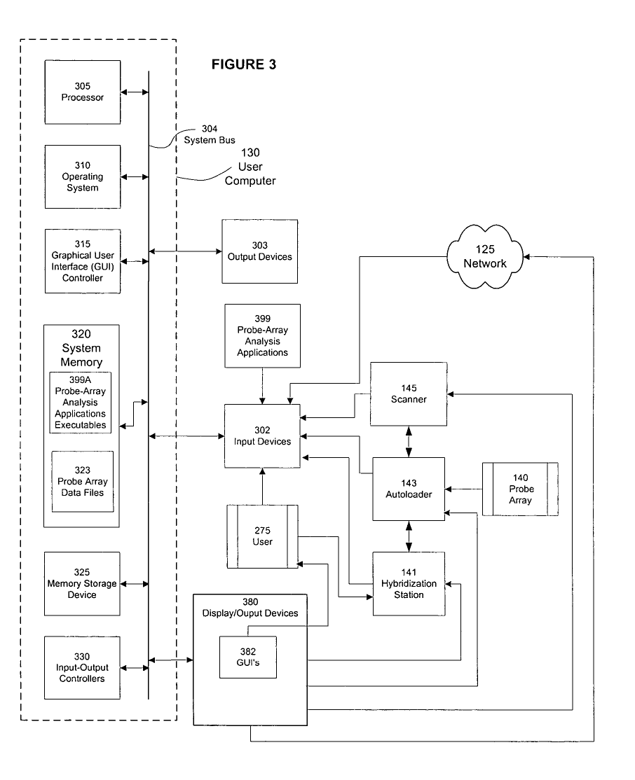

FIG. 3 is a functional block diagram that shows in greater detail illustrative components of a scanner system 100 that, as shown in FIG. 1, may be coupled with LIMS server 120 via a network or otherwise. As noted, high throughput probe array analysis system 100 includes an implementation of user computer 130 and scanner 145.

User Computer 130: User computer 130 may be a computing device specially designed and configured to support and execute some or all of the functions of probe array applications 399, described below. Computer 130 also may be any of a variety of types of general-purpose computers such as a personal computer, network server, workstation, or other computer platform now or later developed. Computer 130 typically includes known components such as a processor 305, an operating system 310, a graphical user interface (GUI) controller 315, a system memory 320, memory storage devices 325, and input-output controllers 330. It will be understood by those skilled in the relevant art that there are many possible configurations of the components of computer 130 and that some components that may typically be included in computer 130 are not shown, such as cache memory, a data backup unit, and many other devices. Processor 305 may be a commercially available processor such as a Pentium® processor made by Intel Corporation, a SPARC® processor made by Sun Microsystems, or it may be one of other processors that are or will become available. Processor 305 executes operating system 310, which may be, for example, a Windows®-type operating system (such as Windows NT® 4.0 with SP6a) from the Microsoft Corporation; a Unix® or Linux-type operating system available from many vendors; another or a future operating system; or some combination thereof. Operating system 310 interfaces with firmware and hardware in a well-known manner, and facilitates processor 305 in coordinating and executing the functions of various computer programs that may be written in a variety of programming languages. Operating system 310, typically in cooperation with processor 305, coordinates and executes functions of the other components of computer 130. Operating system 310 also provides scheduling, input-output control, file and data management, memory management, and communication control and related services, all in accordance with known techniques.

System memory 320 may be any of a variety of known or future memory storage devices. Examples include any commonly available random access memory (RAM), magnetic medium such as a resident hard disk or tape, an optical medium such as a read and write compact disc, or other memory storage device. Memory storage device 325 may be any of a variety of known or future devices, including a compact disk drive, a tape drive, a removable hard disk drive, or a diskette drive. Such types of memory storage device 325 typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 320 and/or the program storage device used in conjunction with memory storage device 325.

In some embodiments, a computer program product is described comprising a computer usable medium having control logic (computer software program, including program code) stored therein. The control logic, when executed by processor 305, causes processor 305 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 330 could include any of a variety of known devices for accepting and processing information from a user, whether a human or a machine, whether local or remote. Such devices include, for example, modem cards, network interface cards, sound cards, or other types of controllers for any of a variety of known input devices 302. Output controllers of input-output controllers 330 could include controllers for any of a variety of known display devices 380 for presenting information to a user, whether a human or a machine, whether local or remote. If one of display devices 380 provides visual information, this information typically may be logically and/or physically organized as an array of picture elements, sometimes referred to as pixels. Graphical user interface (GUI) controller 315 may comprise any of a variety of known or future software programs for providing graphical input and output interfaces between computer 130 and user 275, and for processing user inputs. In the illustrated embodiment, the functional elements of computer 130 communicate with each other via system bus 304. Some of these communications may be accomplished in alternative embodiments using network or other types of remote communications.

As will be evident to those skilled in the relevant art, applications 399, if implemented in software, may be loaded into system memory 320 and/or memory storage device 325 through one of input devices 302. All or portions of applications 399 may also reside in a read-only memory or similar device of memory storage device 325, such devices not requiring that applications 399 first be loaded through input devices 302. It will be understood by those skilled in the relevant art that applications 399, or portions of it, may be loaded by processor 305 in a known manner into system memory 320, or cache memory (not shown), or both, as advantageous for execution.

Probe-Array Analysis Applications 399: Generally, a human being may inspect a printed or displayed image constructed from the data in an image file and may identify those cells that are bright or dim, or are otherwise identified by a pixel characteristic (such as color). However, it frequently is desirable to provide this information in an automated, quantifiable, and repeatable way that is compatible with various image processing and/or analysis techniques. For example, the information may be provided for processing by a computer application that associates the locations where hybridized targets were detected with known locations where probes of known identities were synthesized or deposited. Other methods include tagging individual synthesis or support substrates (such as beads) using chemical, biological, electromagnetic transducers or transmitters, and other identifiers. Information such as the nucleotide or monomer sequence of target DNA or RNA may then be deduced. Techniques for making these deductions are described, for example, in U.S. Pat. No. 5,733,729, which hereby is incorporated by reference in its entirety for all purposes, and in U.S. Pat. No. 5,837,832, noted and incorporated above.

A variety of computer software applications are commercially available for controlling scanners (and other instruments related to the hybridization process, such as hybridization chambers), and for acquiring and processing the image files provided by the scanners. Examples are the Jaguar™ application from Affymetrix, Inc., aspects of which are described in PCT Application PCT/US01/26390 and in U.S. patent applications, Ser. Nos. 09/681,819, 09/682,071, 09/682,074, and 09/682,076, the Microarray Suite application from Affymetrix, aspects of which are described in U.S. Provisional Patent Applications, Serial Nos. 60/220,587, 60/220,645 and 60/312,906, and the GeneChip® Operating Software (hereafter referred to as GCOS) aspects of which are described in U.S. Provisional Application Serial Nos. 60/442,684, titled “System, Method and Computer Software for Instrument Control and Data Acquisition, Analysis, Management and Storage”, filed Jan. 24, 2003, and 60/483,812, titled “System, Method and Computer Software for Instrument Control, Data Acquisition and Analysis”, filed Jun. 30, 2003, all of which are hereby incorporated herein by reference in their entireties for all purposes. For example, image data in image data file 276 may be operated upon to generate intermediate results such as so-called cell intensity files (*.cel) and chip files (*.chp), generated by Microarray Suite or GCOS, or spot files (*.spt) generated by Jaguar™ software. For convenience, the terms “file” or “data structure” may be used herein to refer to the organization of data, or the data itself generated or used by executables 399A and executable counterparts of other applications. However, it will be understood that any of a variety of alternative techniques known in the relevant art for storing, conveying, and/or manipulating data may be employed, and that the terms “file” and “data structure” therefore are to be interpreted broadly. In the case in which an image data file 276 is derived from a GeneChip® probe array, and in which Microarray Suite or GCOS generates a probe array intensity data file. The probe array intensity data file may contain, for each probe scanned by scanner 145, a single value representative of the intensities of pixels measured by scanner 145 for that probe. For example, this value may be a measure of the abundance of tagged cRNA's or PCR products present in the target that hybridized to the corresponding probe. Many such cRNA's or PCR products may be present in each target, as a probe on a GeneChip® probe array may include, for example, millions of oligonucleotides designed to detect the cRNA's or PCR products.

The resulting data stored in the chip file may include degrees of hybridization, absolute and/or differential (over two or more experiments) expression, genotype comparisons, detection of polymorphisms and mutations, and other analytical results. In another example, in which executables 399A includes image data from a spotted probe array, the resulting spot file includes the intensities of labeled targets that hybridized to probes in the array. Further details regarding cell files, chip files, and spot files are provided in U.S. Provisional Patent Application Nos. 60/220,645, 60/220,587, and 60/226,999, incorporated by reference above.

In the present example, in which executables 399A include Affymetrix® Microarray Suite or GCOS, the chip file is derived from analysis of the cell file combined in some cases with information derived from library files. A non-limiting example is illustrated in FIG. 4 as deviation data file (*.tab) 445 that specifies details regarding the sequences and locations of probes and controls. Laboratory or experimental data may also be provided to the software for inclusion in the chip file. For example, an experimenter and/or automated data input devices or programs may provide data related to the design or conduct of experiments. As a non-limiting example, the experimenter may specify an Affymetrix catalogue or custom chip type (e.g., Human Genome U95Av2 chip) either by selecting from a predetermined list presented by Microarray Suite or GCOS or by scanning a bar code related to a chip to read its type. Also, this information may be automatically read. For example, a bar code (or other machine-readable information such as may be stored on a magnetic strip, in memory devices of a radio transmitting module, or stored and read in accordance with any of a variety of other known techniques) may be affixed to the probe array, a cartridge, or other housing or substrate coupled to or otherwise associated with the array. The machine-readable information may automatically be read by a device (e.g., a 1-D or 2-D bar code reader) incorporated within the scanner, an autoloader associated with the scanner, an autoloader movable between the scanner and other instruments, and so on. In any of these cases, Microarray Suite or GCOS may associate the chip type, or other identifier, with various scanning parameters stored in data tables. The scanning parameters may include, for example, the area of the chip that is to be scanned, the starting place for a scan, the location of chrome borders on the chip used for auto-focusing, the speed of the scan, a number of scan repetitions, the wavelength or intensity of laser light to be used in reading the chip, and so on. Rather than storing this data in data tables, some or all of it may be included in the machine-readable information coupled or associated with the probe arrays. Other experimental or laboratory data may include, for example, the name of the experimenter, the dates on which various experiments were conducted, the equipment used, the types of fluorescent dyes used as labels, protocols followed, and numerous other attributes of experiments.

As noted, executables 399A may apply some of this data in the generation of intermediate results. For example, information about the dyes may be incorporated into determinations of relative expression. Other data, such as the name of the experimenter, may be processed by executables 399A or may simply be preserved and stored in files or other data structures. Any of these data may be provided, for example over a network, to a laboratory information management server computer, such as LIMS server 120 of FIGS. 1 and 2, configured to manage information from large numbers of experiments. A data analysis program may also generate various types of plots, graphs, tables, and other tabular and/or graphical representations of analytical data. As will be appreciated by those skilled in the relevant art, the preceding and following descriptions of files generated by executables 399A are exemplary only, and the data described, and other data, may be processed, combined, arranged, and/or presented in many other ways.

The processed image files produced by these applications often are further processed to extract additional data. In particular, data-mining software applications often are used for supplemental identification and analysis of biologically interesting patterns or degrees of hybridization of probe sets. Example of software applications of this type include the Affymetrix® Data Mining Tool, described in U.S. patent application, Ser. No. 09/683,980, and Affymetrix® GeneChip® Data Analysis Software (hereafter referred to as GDAS), described in U.S. Provisional Patent Application Serial No. 60/408,848, titled “System, Method, and Computer Software Product for Determination and Comparison of Biological Sequence Composition”, filed Sep. 6, 2002; and U.S. patent application Attorney Ser. No. 10/657,481, titled “System, Method, and Computer Software Product For Analysis And Display of Genotyping, Annotation, and Related Information”, filed Sep. 9, 2003, each of which is hereby incorporated herein by reference in its entireties for all purposes. Software applications also are available for storing and managing the enormous amounts of data that often are generated by probe-array experiments and by the image-processing and data-mining software noted above. An example of these data-management software applications is the Affymetrix® Laboratory Information Management System (LIMS). In addition, various proprietary databases accessed by database management software, such as the Affymetrix® EASI (Expression Analysis Sequence Information) database and database software, provide researchers with associations between probe sets and gene or EST identifiers.

For convenience of reference, these types of computer software applications (i e., for acquiring and processing image files, data mining, data management, and various database and other applications related to probe-array analysis) are generally and collectively represented in FIG. 3 as probe-array analysis applications 399. FIG. 3 illustratively shows applications 399 stored for execution (as executable code 399A corresponding to applications 399) in system memory 320 of user computer 130.

As will be appreciated by those skilled in the relevant art, it is not necessary that applications 399 be stored on and/or executed from computer 130; rather, some or all of applications 399 may be stored on and/or executed from an applications server or other computer platform to which computer 130 is connected in a network. For example, it may be particularly advantageous for applications involving the manipulation of large databases to be executed from a database server such as user database server 120 of FIG. 1. Alternatively, LIMS, DMT, and/or other applications may be executed from computer 130, but some or all of the databases upon which those applications operate may be stored for common access on server 120 (perhaps together with a database management program, such as the Oracle® 8.0.5 database management system from Oracle Corporation). Such networked arrangements may be implemented in accordance with known techniques using commercially available hardware and software, such as those available for implementing a local-area network or wide-area network. A local network is represented in FIG. 2 by the connection of user computer 130 to LIMS server 120 via a network cable, wireless network, or other means of networking known to those in the related art. Similarly, scanner 145 (or multiple scanners), autoloader 143, or hybridization station 141 may be made available to a network of users over a network cable both for purposes of controlling scanner 145, autoloader 143, or station 141 and for receiving data input from them.

In some implementations, it may be convenient for user 275 to group probe-set identifiers for batch transfer of information or to otherwise analyze or process groups of probe sets together. For example, as described below, user 275 may wish to obtain annotation information related to one or more probe sets identified by their respective probe set identifiers. Rather than obtaining this information serially, user 275 may group probe sets together for batch processing. Various known techniques may be employed for associating probe set identifiers, or data related to those identifiers, together. For instance, user 275 may generate a tab delimited *.txt file including a list of probe set identifiers for batch processing. This file or another file or data structure for providing a batch of data (hereafter referred to for convenience simply as a “batch file”), may be any kind of list, text, data structure, or other collection of data in any format. The batch file may also specify what kind of information user 275 wishes to obtain with respect to all, or any combination of, the identified probe sets. In some implementations, user 275 may specify a name or other user-specified identifier to represent the group of probe-set identifiers specified in the text file or otherwise specified by user 275. This user-specified identifier may be stored by one of executables 399A, so that user 275 may employ it in future operations rather than providing the associated probe-set identifiers in a text file or other format. Thus, for example, user 275 may formulate one or more queries associated with a particular user-specified identifier, resulting in a batch transfer of information from an internet portal to user 275 related to the probe-set identifiers that user 275 has associated with the user-specified identifier. Alternatively, user 275 may initiate a batch transfer by providing the text file of probe-set identifiers. In any of these cases, user 275 may provide information, such as laboratory or experimental information, related to a number of probe sets by a batch operation rather than serial ones. The probe sets may be grouped by experiments, by similarity of probe sets (e.g., probe sets representing genes having similar annotations, such as related to transcription regulation), or any other type of grouping. For example, user 275 may assign a user-specified identifier (e.g., “experiments of January 1”) to a series of experiments and submit probe-set identifiers in user-selected categories (e.g., identifying probe sets that were up-regulated by a specified amount) and provide the experimental information to portal 400 for data storage and/or analysis.

Experiment Manager 520: One possible embodiment of applications executables 399A is illustrated in FIG. 5 as experiment manager 520. Illustrated elements of manager 520 include identifier correlator 525, experiment data and task generator 530, and instrument control manager 540. For example, manager 520 enables automated, high throughput control of instruments involved in hybridizing experimental samples to probe arrays and image acquisition.

In some embodiments of manager 520, identifier correlator 525 receives identifier data 505 from autoloader 143. Alternatively, identifier data 505 may be received from scanner 145 and/or hybridization station 141 in the case that each instrument has an implementation of reader 405. Identifier data 505 could include any probe set identifier previously described or some other type of unique identifier capable of distinctively identifying a specific probe array. Additionally, identifier 505 could include identifiers associated with one or more probe array carousels or magazines, sample holders, samples, users, or any other identifier associated with a probe array experiment. In some implementations identifier data 505 could include one or more identifiers or other data relating to a wide variety of experimental parameters or protocols. Such parameters or protocols could include, for example, scanning parameters or hybridization protocols.

Identifier correlator 525 receives identifier data 505 and associates the one or more unique identifiers with data required for executing automated procedures. For example, a single implementation of data 550 may contain data associated with each implementation of probe array cartridge 600 and associated experiment information. Alternatively, there may be a separate implementation of data 550 associated with each implementation of probe array cartridge 600. In the present example, the experiment information may include information associated with hybridization protocols, post-hybridization processing protocols, and/or image acquisition protocols.

In some embodiments, data 550 may be a single data file, database, or other type of data structure. Alternatively data 550 may represent data acquired from a plurality of data files or databases. Data 550 may be stored locally such as in probe array data files 323 or remotely such as in one or more databases that could be located, for example, on LIMS server 120. In the illustrated implementation, user 275 may create and/or update data 550. Identifier correlator 525 may retrieve and forward data 550 to generator 530. Alternatively, correlator 525 could forward generator 530 a pointer, link, or some other method of identifying the location of a data file or database and/or data within a data file or database.

Additionally, correlator 525 may look for data not included in data 550 from one or more local or remote sources such as LIMS server 120. The data could similarly be identified by the one or more identifiers of identifier data 505. The remote data may include scanning parameters by probe array type, hybridization protocols, lot number, expiration date, part number, or other type of data. The remote data could also be incorporated into experiment data 550 by generator 530. Alternatively the remote data could be forwarded to instrument control manager 540 for direct implementation in an automated process.

Generator 530 may update data 550 with retrieved data associated to the one or more identifiers. Generator 530 may also receive data input by user 275 such as parameter data 555. Generator 530 may use data 555 to generate additional data. For example, data 555 may include the RNA concentration of an experimental sample. Generator 530 calculates the volumes of buffers, reagents, and other data based, at least in part, upon the RNA concentration value. The RNA concentration and calculated data may be stored in data 550 and further utilized by generator 530 to optimize the hybridization process performed by hybridization station 141.

Generator 530 may store data 555 in data 550 and/or use in one or more automated procedures. Additionally, generator 530 may forward data to input-output controllers 330 for incorporation into a graphical user interface, illustrated in FIG. 3 as GUI 382. GUI 382 may include an interactive format, where the user may make one or more selections based upon data presented in GUI 382. The one or more user selections are returned to generator 530 and could be incorporated into one or more protocols or procedures, and/or stored in one or more data files/databases such as experiment data 550.

Generator 530 determines each step to be performed in the automated process based, at least in part, upon data 550. Elements of data 550 could include what steps in the automation process have been performed or alternatively include steps that remain to be performed. In the presently described implementation, generator 530 generates commands to be implemented by instrument control manager 540. Also, the automated process could be operated in a variety of different modes. For example, one mode could include completing each process in a serial fashion. For instance, hybridization station 141 may process all of the available probe arrays prior to scanning any probe array. Alternatively, the operations of various components may operate cooperatively. For example, once the first probe array has been fully processed by hybridization station 141 it may proceed directly to scanner 145 via autoloader 143 for image acquisition. In the present example some operations may require more time to complete and be a rate-limiting step in the process. Generator 530 manages the tasks performed by each component to maximize efficiency based, at least in part upon one or more rate limiting steps.

Instrument control manager 540 receives commands, parameter and protocol data from generator 530. Manager 540 implements the commands according to the additional parameter and protocol data. Additionally, manager 540 may perform some operations in an automated fashion, without a command from generator 530. Such automated operations could include loading the next available probe array into scanner 145 or hybridization station 141 by autoloader 143. Autoloader 143 or manager 540 may independently determine the availability of probe array cartridge 600 for a particular step in a process. For example, manager 540 signals autoloader 143 to load the next available probe array cartridge 600 into scanner 145. Autoloader 143 scans the barcode label affixed to the probe array housing prior to loading the probe array into scanner 145. Autoloader 143 forwards identifier data 505 to identifier correlator 525 that finds associated data in experiment data 550 as well as scanning parameter data for the probe array type stored in one or more library files on LIMS 120. The link to data 550, as well as the scanning parameter data, is forwarded to generator 530. Generator 530 confirms that scanning is the next step in the process for that probe array and signals manager 540 to load and scan the probe array using the scanning parameters and relevant data from data 550. After scanner 145 acquires an image, the image data may be forwarded to generator 530 via manager 540 for storage in one or more data files that could include data 550.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments. For example, some or all of the functions described as being carried out by experiment data and task generator 530 could be carried out by instrument control manager 540, or these functions could otherwise be distributed among other functional elements. Also, the functions of several elements may, in alternative embodiments, be carried out by fewer, or a single, element. For example, the functions of experiment data and task generator 530 and instrument control manager 540 could be carried out by a single element in other implementations. Similarly, in some embodiments, any functional element may perform fewer, or different, operations than those described with respect to the illustrated embodiment. Also, functional elements shown as distinct for purposes of illustration may be incorporated within other functional elements in a particular implementation. For example, the functions performed by the two servers could be performed by a single server or other computing platform, distributed over more than two computer platforms, or other otherwise distributed in accordance with various known computing techniques.

Also, the sequencing of functions or portions of functions generally may be altered. Certain functional elements, files, data structures, and so on, may be described in the illustrated embodiments as located in system memory of a particular computer. In other embodiments, however, they may be located on, or distributed across, computer systems or other platforms that are co-located and/or remote from each other. For example, any one or more of data files or data structures described as co-located on and “local” to a server or other computer may be located in a computer system or systems remote from the server. In addition, it will be understood by those skilled in the relevant art that control and data flows between and among functional elements and various data structures may vary in many ways from the control and data flows described above or in documents incorporated by reference herein. More particularly, intermediary functional elements may direct control or data flows, and the functions of various elements may be combined, divided, or otherwise rearranged to allow parallel processing or for other reasons. Also, intermediate data structures or files may be used and various described data structures or files may be combined or otherwise arranged. Numerous other embodiments, and modifications thereof, are contemplated as falling within the scope of the present invention as defined by appended claims and equivalents thereto.

What is claimed is:

1. A system for high throughput processing of a plurality of probe arrays, comprising:
a means for holding a plurality of cartridges, wherein each cartridge includes a probe array capable of detecting biological molecules;
a means for interfacing with each cartridge; and
a manifold constructed and arranged to couple each cartridge with one or more reservoirs, wherein each cartridge is coupled via the means for interfacing.

2. The system of claim 1, wherein:
the means for holding includes a carousel or magazine.

3. The system of claim 1, wherein:
the carousel includes a plurality of partitions, wherein each partition includes an associated ultrasonic agitator.

4. The system of claim 3, wherein:
the associated ultrasonic agitator provides vibration, wherein the vibration aids in mixing fluids.

5. The system of claim 1, wherein:
each cartridge includes an aperture for accepting the means for interfacing.

6. The system of claim 1, wherein:
each cartridge includes at least two channels coupled by a first pocket.

7. The system of claim 6, wherein:
the first pocket houses the probe array.

8. The system of claim 6, wherein:
one of the at least two channels includes a second pocket.

9. The system of claim 8, wherein:
the second pocket includes an air pocket, wherein the air pocket is constructed and arranged to form of a bubble.

10. The system of claim 9, wherein:
the bubble includes air or gas.

11. The system of claim 9, wherein:
the bubble aids in mixing fluids.

12. The system of claim 1, wherein:
the probe array includes a synthesized probe array.

13. The system of claim 1, wherein:
the probe array includes a spotted probe array.

14. The system of claim 1, wherein:
the means for interfacing includes a pin or needle.

15. The system of claim 14, wherein:
the needle includes a dual lumen needle having an outer lumen and an inner lumen.

16. The system of claim 15, wherein:
the outer lumen is constructed and arranged for the removal of fluids or gas and the inner lumen is constructed and arranged for the introduction of fluids or gas.

17. The system of claim 1, wherein:
each of the one or more reservoirs includes a fluid.

18. The system of claim 17, wherein:
the fluid is a sample, wash, buffer, stain, bleach, or water.

19. The system of claim 1, further comprising:
a fluid bath constructed and arranged to provide thermal control of each of the cartridges.

20. The system of claim 19, wherein:
the thermal control promotes hybridization efficiency of a plurality of biological targets to the probe array.

21. A method, comprising the acts of:
holding a plurality of cartridges, wherein each cartridge includes a probe array capable of detecting biological molecules;
interfacing with each cartridge; and
coupling each cartridge with one or more reservoirs, wherein each cartridge is coupled via the interface.

22. The method of claim 21, wherein:
each cartridge includes an aperture for interfacing.

23. The method of claim 21, wherein:
each cartridge includes at least two channels coupled by a first pocket.

24. The method of claim 23, wherein:
the first pocket houses the probe array.

25. The system of claim 21, wherein:
the probe array includes a synthesized probe array.

26. The system of claim 21, wherein:
the probe array includes a spotted probe array.

27. The system of claim 21, wherein:
each of the one or more reservoirs includes a fluid.

28. The system of claim 27, wherein:
the fluid is a sample, wash, buffer, stain, bleach, or water.

29. A system, comprising:
a carousel constructed and arranged to hold a plurality of cartridges, wherein each cartridge includes a probe array capable of detecting biological molecules;
a fluid bath constructed and arranged to provide thermal control of each of the cartridges;
a dual lumen needle constructed and arranged to interface with each cartridge; and
a manifold constructed and arranged to couple each cartridge with one or more reservoirs, wherein each cartridge is coupled via the dual lumen needle.

30. The system of claim 29, wherein:
the carousel includes a plurality of partitions, wherein each partition includes an associated ultrasonic agitator.

31. The system of claim 30, wherein:
the associated ultrasonic agitator provides vibration, wherein the vibration aids in mixing fluids.

32. The system of claim 29, wherein:
the probe array includes a synthesized probe array.

33. The system of claim 29, wherein:
the probe array includes a spotted probe array.

34. The system of claim 29, wherein:
the dual lumen needle includes an outer lumen and an inner lumen.

35. The system of claim 34, wherein:
the outer lumen is constructed and arranged for the removal of fluids or gas and the inner lumen is constructed and arranged for the introduction of fluids or gas.

36. The system of claim 29, wherein:
each of the one or more reservoirs includes a fluid.

37. The system of claim 36, wherein:
the fluid is a sample, wash, buffer, stain, bleach, or water.

38. The system of claim 29, wherein:
the thermal control promotes hybridization efficiency of a plurality of biological targets to the probe array.

39. A method, comprising the acts of:
holding a plurality of cartridges, wherein each cartridge includes a probe array capable of detecting biological molecules;
providing thermal control of each of the cartridges;
interfacing with each cartridge; and
coupling each cartridge with one or more reservoirs, wherein each cartridge is coupled via the interface.

40. A method, comprising the acts of:
holding a plurality of cartridges, wherein each cartridge includes a probe array capable of detecting biological molecules;
interfacing with each cartridge;
coupling each cartridge with one or more reservoirs, wherein each cartridge is coupled via the interface; and
serially introducing a plurality of fluids into the probe array cartridge.
